(19) United States
(12) Patent Application Publication
(10) Pub. No.: US 2026/0287893 A1
(43) Pub. Date: Sep. 24, 2026

(54) LIGHT GUIDE PLATE UNIT AND IMAGE DISPLAY DEVICE

(71) Applicant: SONY GROUP CORPORATION, Tokyo (JP)

(72) Inventors: Kentaro KATO, Kanagawa (JP); Kazue SHIMIZU, Kanagawa (JP); Christophe PEROZ, Tokyo (JP); Chieh CHANG, New Taipei City (TW); Mieko KUWAHARA, Kanagawa (JP)

(73) Assignee: SONY GROUP CORPORATION, Tokyo (JP)

(21) Appl. No.: 18/996,238

(22) PCT Filed: Jul. 21, 2023
(86) PCT No.: PCT/JP2023/026810

§ 371 Date: Jan. 17, 2025

(30) Foreign Application Priority Data
Jul. 26, 2022 (JP) 2022-118480
Jul. 18, 2023 (JP) 2023-116991

(51) Int. Cl. G02B 27/01

(52) U.S. Cl. CPC G02B 27/0172; G02B 2027/011; G02B 2027/0125; G02B 2027/0178

(57) ABSTRACT

A technology for reducing an adverse effect caused by a structure formed near a diffraction grating is provided. The present disclosure provides a light guide plate unit including: a light guide plate; a first diffraction grating on a first surface side of the light guide plate, a second diffraction grating on the first surface side of the light guide plate, and a transition zone structure on the first surface side of the light guide plate. The transition zone structure extends from a first end point at or adjacent to the first diffraction grating to a vertex point, and from the vertex point to a second end point at or between the first end point and the second diffraction grating. The first and second end points are closer to the first surface of the light guide plate than the vertex point.

### CROSS REFERENCE TO RELATED APPLICATIONS

This application claims the benefits of Japanese Priority Patent Application JP 2022-118480 filed on Jul. 26, 2022, and Japanese Priority Patent Application JP 2023-116991 filed on Jul. 18, 2023, the entire contents of which are incorporated herein by reference.

### TECHNICAL FIELD

The present disclosure relates to a light guide plate unit and an image display device, and more particularly relates to a light guide plate unit having a diffraction grating and an image display device including the light guide plate unit.

A type of device for displaying a video includes a head mounted display device (also called an HMD). The HMD has come to be used in various aspects. Some HMDs use a technology of displaying an image superimposed on an external scene. The technology is also called augmented reality (AR) technology, and a product using the technology includes AR glasses. Furthermore, the HMD can also be used to perform video display based on the virtual reality technology.

Various proposals have been made so far regarding the augmented reality technology and the virtual reality technology. For example, PTL 1 below discloses a method for forming an optical waveguide. The method includes forming a metasurface in a specific technique. Furthermore, PTL 2 below discloses a waveguide for a display system. The waveguide includes a first portion and a second portion that cause a specific phase change.

### CITATION LIST

### Patent Literature

PTL 1: JP 2021-176016A
PTL 2: WO 2016/130358A

### SUMMARY

### Technical Problem

In a case where a diffraction grating is provided on a light guide plate, a structure including a material for forming the diffraction grating may also occur near the diffraction grating. Such a structure may affect the travel of light guided in the light guide plate and adversely affect an image presented. Therefore, an object of the present disclosure is to provide a technology for reducing an adverse effect caused by a structure formed near a diffraction grating.

### Solution to Problem

A light guide plate unit and an image display device incorporating a light guide plate unit are provided. In accordance with embodiments of the present disclosure, the light guide plate unit includes a light guide plate, a first diffraction grating, and a transition zone (TZ) structure. Some or all of the first diffraction grating, the second diffraction grating, and the transition zone structure may be disposed on a first surface side of the light guide plate.

In accordance with at least some embodiments of the present disclosure, the transition zone structure extends from a first end point at or adjacent to the first diffraction grating to a vertex point, and from the vertex pint to a second end point at or between the first end point and the second diffraction grating.

In accordance with other embodiments of the present disclosure, the transition zone structure is between the first diffraction grating and the second diffraction grating, which are all disposed on the first surface side of the light guide plate. In addition, the light guide plate unit can include a coating layer on at least portions of a side of the transition zone structure opposite a side of the transition zone structure adjacent the first surface side of the light guide plate.

In accordance with still other embodiments of the present disclosure, a part of the transition zone structure is between the first diffraction grating and the second diffraction grating. In addition, a reflective coating layer is disposed on the first surface side of the light guide plate, and between the transition zone structure and the first surface side of the light guide plate.

In accordance with still further embodiments, the present disclosure provides
a light guide plate unit including:
a light guide plate; and
a structure having a first diffraction grating provided on one surface of the light guide plate, a second diffraction grating that diffracts light diffracted by the first diffraction grating, and a mountain shape existing between the first diffraction grating and the second diffraction grating, in which
the light guide plate unit is configured to satisfy the following Mathematical Expression 1 when an MTF value of light immediately before entering the mountain shape in a case where a spatial frequency is 10 cycle/deg is X₁₀ and an MTF value of light immediately after passing through the mountain shape is Y₁₀. Note that, where used in the mathematical expressions contained herein, each of A′, B′, X₁₀, Y₁₀, X₂₀, and Y₂₀ is a percentage value indicated in the range of 0 to 1.

$$\begin{matrix}[ Math . 1 ] & \\ 0 ≦ ( 1 - {Y}_{10} / {X}_{10} ) ≦ 0.5 & ( Mathematical Expression 1 )\end{matrix}$$

In a case where “a width of a slope of the mountain shape” is less than “a total reflection interval of the light in the light guide plate”, “the slope” may be configured in such a manner that “a width of the slope” is equal to or less than “a threshold specified on the basis of the total reflection interval”, and
in a case where “a width of a slope of the mountain shape” is equal to or greater than “a total reflection interval of the light in the light guide plate”, “the slope” may be configured in such a manner that “a height of the slope” is equal to or less than “a threshold specified on the basis of a width of the slope and an inclination angle of the slope”.

In a case where each of a width w1 of a slope 1 on the first diffraction grating side of the mountain shape and a width w2 of a slope 2 on the second diffraction grating side is equal to or greater than a total reflection interval d of the light in the light guide plate,
the mountain shape is configured in such a manner that a height h1 of the slope 1 and a height h2 of the slope 2 satisfy the following Mathematical Expression 2,

$$\begin{matrix}[ Math . 2 ] & \\ \begin{matrix}0 < h 1 ≦ w 1 * tan ( 0.025 [ deg ] * A ) \\ and \\ 0 < h 2 ≦ w 2 * tan ( 0.025 [ deg ] * A )\end{matrix} \} & ( Mathematical Expression 2 )\end{matrix}$$

where, in Mathematical Expression 2,
h1=(height from reference surface of the first diffraction grating to vertex of the mountain shape)
w1=(width of slope 1)
h2=(height from reference surface of the second diffraction grating to vertex of the mountain shape)
w2=(width of slope 2)

$${A = cos ( {θ}_{a i r i n} ) / ( 2 * {n}_{2} * cos ( θ ’}_{TIR} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape), in a case where the width w1 of the slope 1 on the first diffraction grating side of the mountain shape is less than the total reflection interval d of the light in the light guide plate, and the width w2 of the slope 2 on the second diffraction grating side is equal to or greater than the total reflection interval d of the light in the light guide plate,
the mountain shape is configured in such a manner that the width w1 of the slope 1 and the height h2 of the slope 2 satisfy the following Mathematical Expression 3,

$$[ Math . 3 ]$$

$$\begin{matrix}0 < w 1 ≦ 0.23 * d \\ and \\ 0 < h 2 ≦ w 2 * tan ( 0.025 [ deg ] * A )\end{matrix} \} \qquad ( Mathematical Expression 3 )$$

where, in Mathematical Expression 3,
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape), and,
in a case where each of the width w1 of the slope 1 on the first diffraction grating side and the width w2 of the slope 2 on the second diffraction grating side of the mountain shape is less than the total reflection interval d of the light in the light guide plate, the mountain shape may be configured in such a manner that the width w1 of the slope 1 and the width w2 of the slope 2 satisfy the following Mathematical Expression 4.

$$[ Math . 4 ]$$

$$\begin{matrix}0 < w 1 ≦ 0.15 * d \\ and \\ 0 < w 2 ≦ 0.15 * d\end{matrix} \} \qquad ( Mathematical Expression 4 )$$

where, in Mathematical Expression 4,
w1=(width of slope 1)
w2=(width of slope 2).

The light guide plate unit may be configured to satisfy the following Mathematical Expression 5 when an MTF value of light immediately before entering the mountain shape in a case where a spatial frequency is 20 cycle/deg is X₂₀ and an MTF value of light immediately after passing through the mountain shape is Y₂₀.

$$[ Math . 5 ]$$

$$0 ≦ ( 1 - {Y}_{20} / {X}_{20} ) ≦ 0.5 \qquad ( Mathematical Expression 5 )$$

In a case where each of a width w1 of a slope 1 on the first diffraction grating side and a width w2 of a slope 2 on the second diffraction grating side of the mountain shape is equal to or greater than a total reflection interval d of the light in the light guide plate, the mountain shape is configured in such a manner that a height h1 of the slope 1 and a height h2 of the slope 2 satisfy the following Mathematical Expression 6,

$$[ Math . 6 ]$$

$$\begin{matrix}0 < h 1 ≦ w 1 * tan ( 0.0125 [ deg ] * A ) \\ and \\ 0 < h 2 ≦ w 2 * tan ( 0.0125 [ deg ] * A )\end{matrix} \} \qquad ( Mathematical Expression 6 )$$

where, in Mathematical Expression 6,
h1=(height from reference surface of the first diffraction grating to vertex of the mountain shape)
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape),
in a case where the width w1 of the slope 1 on the first diffraction grating side is less than the total reflection interval d of the light in the light guide plate, and the width w2 of the slope 2 on the second diffraction grating side of the mountain shape is equal to or greater than the total reflection interval d of the light in the light guide plate, the mountain shape is configured in such a manner that the width w1 of the slope 1 and the height h2 of the slope 2 satisfy the following Mathematical Expression 7,

$$[ Math . 7 ]$$

$$\begin{matrix}0 < w 1 ≦ 0.2 * d \\ and \\ 0 < h 2 ≦ w 2 * tan ( 0.0125 [ deg ] * A )\end{matrix} \} \qquad ( Mathematical Expression 7 )$$

where, in Mathematical Expression 7,
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape), and,
in a case where each of the width w1 of the slope 1 on the first diffraction grating side and the width w2 of the slope 2 on the second diffraction grating side of the mountain shape is less than the total reflection interval d of the light in the light guide plate, the mountain shape may be configured in such a manner that the width w1 of the slope 1 and the width w2 of the slope 2 satisfy the following Mathematical Expression 8.

$$[ Math . 8 ]$$

$$\begin{matrix}0 < w 1 ≦ 0.15 * d \\ and \\ 0 < w 2 ≦ 0.15 * d\end{matrix} \} \qquad ( Mathematical Expression 8 )$$

where, in Mathematical Expression 8,
w1=(width of slope 1)
w2=(width of slope 2).

The light guide plate unit may further include, on the one surface or the other surface of the light guide plate, a second structure having a mountain shape configured to cancel an angle deviation of the light caused by the structure (hereinafter called “first structure”).

The width w1 of the slope 1 on the first diffraction grating side of the first structure may be configured to satisfy

$$w 1 < 0.1 d$$

(here, d is a total reflection interval of the light in the light guide plate).

In a case where the width w2 of the slope 2 on the second diffraction grating side of the first structure is equal to or greater than the total reflection interval d of the light, the mountain shape of the second structure is configured to satisfy any of the following Mathematical Expressions 9-1, 9-2, and 9-3,

$$[ Math . 9 ]$$

$$\begin{matrix}- 1 \leq \frac{Δφ}{{φ}_{2}} \leq 1 - \vert \frac{Δ w}{d / 2} - 2 n \vert \\ \& \vert \frac{Δ w}{d / 2} - 2 n \vert \leq 1 \\ \& - {w}_{2} < Δ w\end{matrix} \} or \qquad ( Mathematical Expression 9 - 1 )$$

$$\begin{matrix}- 1 \leq \frac{Δφ}{{φ}_{2}} \leq 1 - 4 \vert \frac{Δ x}{d / 2} - 2 n \vert \\ \& \vert \frac{Δ x}{d / 2} - 2 n \vert \leq \frac{1}{2}\end{matrix} \} or \qquad ( Mathematical Expression 9 - 2 )$$

$$\begin{matrix}1 - 4 \vert \frac{Δ x}{d / 2} - 2 n \vert \leq \frac{Δφ}{{φ}_{2}} \leq - 1 \\ \& \frac{1}{2} \leq \vert \frac{Δ x}{d / 2} - 2 n \vert \leq 1\end{matrix} \} \qquad ( Mathematical Expression 9 - 3 )$$

where, in Mathematical Expressions 9-1, 9-2, and 9-3,
Δφ is a tolerance of slope angle of mountain shape of the second structure,
φ₂ is an angle formed by a slope 2 on the second diffraction grating side of the first structure and the first surface of the light guide plate,
Δw is a tolerance of slope width of mountain shape of the second structure,
d is a total reflection interval of the light as described above,
n is any integer,

Δx is an error of x, and x is ((half total reflection interval of light beam)+ (integer multiple of total reflection interval of light beam)),
w₂ is width w2 of slope 2 on the second diffraction grating side of the first structure, and
in a case where the width w2 of the slope 2 on the second diffraction grating side of the first structure is less than the total reflection interval d of the light, the mountain shape of the second structure may be configured to satisfy any of the following Mathematical Expressions 10-1, 10-2, and 10-3.

$$[ Math . 10 ]$$

$$\begin{matrix}\vert \frac{Δφ}{{φ}_{2}} \vert \leq 1 & \& & - 1 \leq \frac{Δ w}{{w}_{2}} \leq 0\end{matrix} or \qquad ( Mathematical Expression 10 - 1 )$$

$$\begin{matrix}\vert \frac{Δφ}{{φ}_{2}} \vert \leq \frac{1}{4} & \& & 0 \leq \frac{Δ w}{{w}_{2}} \leq 1\end{matrix} or \qquad ( Mathematical Expression 10 - 2 )$$

$$\begin{matrix}\vert \frac{Δφ}{{φ}_{2}} \vert \leq \frac{1}{2} & \& & \vert \frac{Δ x}{{w}_{2}} \vert \leq \frac{1}{2}\end{matrix} \qquad ( Mathematical Expression 10 - 3 )$$

where, in Mathematical Expressions 10-1, 10-2, and 10-3,
Δφ is a tolerance of slope angle of mountain shape of the second structure,
φ₂ is an angle formed by a slope 2 on the second diffraction grating side of the first structure and the first surface of the light guide plate,
Δw is a tolerance of slope width of mountain shape of the second structure,
Δx is an error of x, and x is ((half total reflection interval of light beam)+ (integer multiple of total reflection interval of light beam)),
w₂ is width w2 of slope 2 on the second diffraction grating side of the first structure.

A zone where the structure exists may be provided with
a reflective coating layer configured to prevent the light from entering the structure, or
a coating layer configured to prevent the light having entered the structure from causing an angle deviation due to a slope of the mountain shape.

The reflective coating layer may be provided between the light guide plate and the structure.

The coating layer may include a material having a refractive index that is substantially the same as a refractive index of the structure.

A structure having a plurality of mountain shapes may be included between the first diffraction grating and the second diffraction grating, in which heights of all of the plurality of mountain shapes may be equal to or less than 90 nm.

The first diffraction grating is any diffraction grating of an incident diffraction grating configured to diffract light entering the light guide plate and cause the light to travel in the light guide plate, an expander configured to expand the light having traveled in the light guide plate, and an emission diffraction grating configured to emit the light from the light guide plate, and the second diffraction grating may be a recycler that diffracts light passing through the first diffraction grating and traveling toward an end of the light guide plate and causes the light to travel to the first diffraction grating again.

The first diffraction grating is an incident diffraction grating configured to diffract light entering the light guide plate and cause the light to travel in the light guide plate, and the second diffraction grating may be an expander configured to expand the light diffracted by the first diffraction grating and having traveled in the light guide plate.

The first diffraction grating is an expander configured to expand light having traveled in the light guide plate, and
the second diffraction grating may be an emission diffraction grating configured to emit, from the light guide plate, light expanded by the expander.

The first diffraction grating is an incident diffraction grating configured to diffract light entering the light guide plate and cause the light to travel in the light guide plate, and
the second diffraction grating may be an emission diffraction grating configured to emit, from the light guide plate, light having traveled in the light guide plate.

The emission diffraction grating may be an emission diffraction grating configured to expand light having traveled in the light guide plate and emit the light from the light guide plate.

The mountain shape structure may include a material used for forming the first diffraction grating, the second diffraction grating, or both of these diffraction gratings.

The light guide plate unit may be used for manufacturing an image display device.

Furthermore, the present disclosure also provides
an image display device including:
a light guide plate unit including
a light guide plate, and
a structure having a first diffraction grating provided on one surface of the light guide plate, a second diffraction grating that diffracts light diffracted by the first diffraction grating, and a mountain shape existing between the first diffraction grating and the second diffraction grating, in which
the light guide plate unit is configured to satisfy the following Mathematical Expression 1 when an MTF value of light immediately before entering the mountain shape in a case where a spatial frequency is 10 cycle/deg is X₁₀ and an MTF value of light immediately after passing through the mountain shape is Y₁₀.

$$[ Math . 11 ]$$

$$0 ≦ ( 1 - {Y}_{10} / {X}_{10} ) ≦ 0.5 \qquad ( Mathematical Expression 1 )$$

### BRIEF DESCRIPTION OF DRAWINGS

FIG. 1 is a schematic diagram of an example of a light guide plate including a diffraction grating.

FIGS. 2A and 2B are views for explaining a mechanism for forming a TZ.

FIG. 3 is a view for explaining image quality degradation due to the TZ.

FIG. 4A is a view for explaining an incident light beam and an emission light beam that are referred to for specifying the TZ.

FIG. 4B is a view for explaining a place of the TZ.

FIG. 4C is a view for explaining a place of the TZ.

FIGS. 5A to 5E are schematic diagrams illustrating examples of a shape of the TZ.

FIG. 6 is a view for explaining a definition of the shape of the TZ.

FIG. 7 is a view for explaining a parameter used in the present disclosure.

FIG. 8 is a schematic diagram of an example of a light guide plate unit of the present disclosure.

FIGS. 9A and 9B are schematic diagrams for explaining a relationship among the TZ shape, a PSF, and an MTF.

FIG. 10 is a distribution diagram of MTF values.

FIG. 11 is a distribution diagram of MTF values.

FIG. 12 is a distribution diagram of MTF values.

FIG. 13 is a distribution diagram of MTF values.

FIG. 14 is a distribution diagram of MTF values.

FIG. 15 is a distribution diagram of MTF values.

FIG. 16 is a schematic diagram of an example of a light guide plate unit having the TZ and a TZc.

FIG. 17 is a schematic diagram of an example of a light guide plate unit having the TZ and the TZc.

FIG. 18 is a distribution diagram of MTF values.

FIG. 19 is a distribution diagram of MTF values.

FIG. 20 is a distribution diagram of MTF values.

FIG. 21 is a distribution diagram of MTF values.

FIG. 22 is a schematic diagram of an example of a light guide plate unit having the TZ and the TZc.

FIG. 23 is a schematic diagram of an example of a light guide plate unit provided with a reflective coating layer.

FIG. 24 is a schematic diagram of an example of a light guide plate unit having a coating layer.

FIGS. 25A and 25B are views for explaining MTF degradation suppression in a structure having a plurality of mountain shapes.

FIG. 26 is a flowchart of an example of a manufacturing method of the light guide plate unit according to the present disclosure.

FIGS. 27A and 27B are views for explaining deposition of a resist material.

FIG. 28 is a schematic diagram illustrating an example of an image display device.

FIG. 29A is a schematic diagram of a measurement system for measuring an MTF.

FIG. 29B is a view for explaining details of components included in the measurement system for measuring an MTF.

FIG. 30A is a flowchart of an MTF measurement method.

FIG. 30B is a flowchart of the MTF measurement method.

FIG. 31A is a view illustrating a configuration example of a diffraction grating provided on the light guide plate.

FIG. 31B is a view illustrating a configuration example of a diffraction grating provided on the light guide plate.

FIG. 32A is a view illustrating a configuration example of a diffraction grating provided on the light guide plate.

FIG. 32B is a view illustrating a configuration example of a diffraction grating provided on the light guide plate.

FIG. 32C is a view illustrating a configuration example of a diffraction grating provided on the light guide plate.

FIG. 32D is a view illustrating a configuration example of a diffraction grating provided on the light guide plate.

FIG. 32E is a view illustrating a configuration example of a diffraction grating provided on the light guide plate.

### DESCRIPTION OF EMBODIMENTS

Preferred embodiments for carrying out the present disclosure will be described below. Note that the embodiments described below illustrate representative embodiments of the present disclosure, and the scope of the present disclosure is not limited only to these embodiments.

The present disclosure will be described in the following order.
1. First Embodiment (Light Guide Plate Unit)
1.1 Overview of Present Disclosure
1.2 Definition Regarding TZ and Various Types of Parameters
1.3 Example 1 of Condition Regarding MTF
1.3.1 Example of Specification of Slope
1.3.2 Deviation of Light Beam Angle Caused by One Slope
1.3.3 Relationship among TZ Shape, PSF, and MTF
1.4 Configuration Example 1 of Slope
1.4.1 Configuration Example 1-1 (Case Where Both Widths of Two Slopes are Large)
1.4.2 Configuration Example 1-2 (Case Where Width of One Slope is Large and Width of Other Slope is Small)
1.4.3 Configuration Example 1-3 (Case Where Both Widths of Two Slopes are Small)
1.5 Example 2 of Condition Regarding MTF
1.6 Configuration Example 2 of Slope
1.6.1 Configuration Example 2-1 (Case Where Widths of Two Slopes are Large)
1.6.2 Configuration Example 2-2 (Case Where Width of One Slope is Large and Width of Other Slope is Small)
1.6.3 Configuration Example 2-3 (Case Where Widths of Two Slopes are Small)
1.7 Configuration Example of the TZc
1.7.1 Example 1 of TZc Existing on Surface on Opposite Side to Surface where TZ Exists
1.7.2 Example 2 of TZc Existing on Surface on Opposite Side to Surface where TZ Exists
1.7.3 Example 1 of TZc Existing on Surface where TZ Exists
1.7.4 Example 2 of TZc Existing on Surface where TZ Exists
1.8 Coating Layer
1.8.1 Example of Reflective Coating Layer
1.8.2 Example of Coating Layer
1.9 Example of Case of Having Structure Having Plurality of Mountain Shapes
1.10 Manufacturing Method
1.11 Use Method
2. Second Embodiment (Image Display Device)

### 1. First Embodiment (Light Guide Plate Unit)

### 1.1 Overview of Present Disclosure

In an eyeglass-type eyewear, a light guide plate having a surface relief gratings (SRG) structure may be used. The light guide plate is provided with a diffraction grating on a light guide plate surface. The diffraction grating may be formed using, for example, a nanoimprint technique, but depending on a formation method, a structure including a material forming the diffraction grating may be formed near the diffraction grating. In the present description, a zone where the structure exists is also called a transition zone (TZ). The thickness of the TZ in a perpendicular direction with respect to the light guide plate surface is non-uniform over the TZ, and this may affect a light beam guided in the light guide plate and may cause further image quality degradation. Such TZ is particularly likely to occur, for example, in a case where the diffraction grating is formed by further combining the nanoimprint technique described above with an inkjet method.

The problem regarding the TZ described above will be described in more detail below with reference to the drawings.

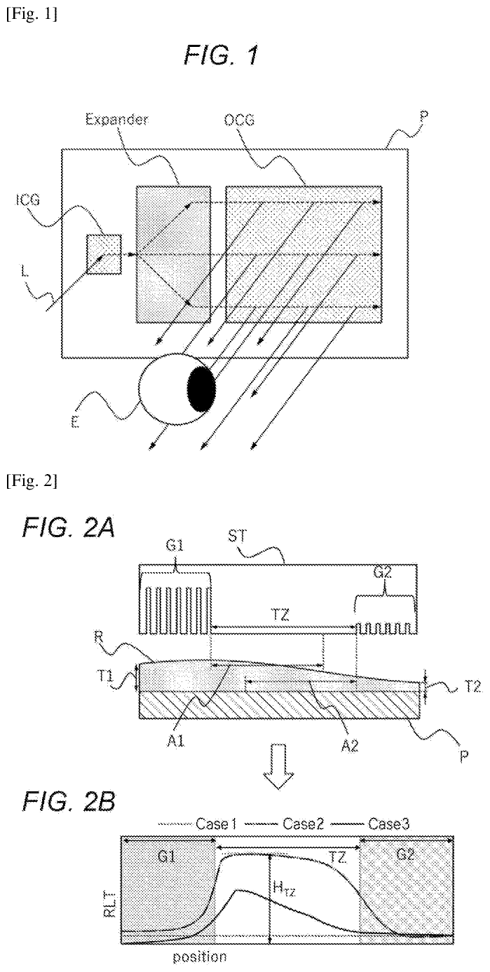

FIG. 1 illustrates a schematic diagram of an example of a light guide plate including a diffraction grating. For example, in order to cause a light beam L emitted from a drawing engine to reach the eye of a user via a light guide plate, a light guide plate P illustrated in the figure is provided with at least two or more diffraction gratings of a diffraction grating (in-coupling grating (ICG)) for taking the light beam into the light guide plate and a diffraction grating (out-coupling grating (OCG)) for emitting the light beam from the light guide plate. The light emitted from the light guide plate P by the OCG reaches an observer (particularly, an eye E of the observer). Furthermore, in general, a diffraction grating (expander) having a function of dividing a light beam in the light guide plate is also provided.

When a light guide plate manufacturing process in which a nanoimprint technique and an inkjet technique is combined is adopted to form such a diffraction grating on the light guide plate surface, a zone (TZ) having a non-uniform thickness shape is formed around the diffraction grating. The mechanism by which the TZ is formed will be described with reference to FIGS. 2A and 2B.

As illustrated in FIG. 2A, a diffraction grating is formed by molding, with a stamper ST, a resist material R applied onto the substrate by inkjet printing. In the stamper ST, a plurality of grooves in a G1 zone are grooves for obtaining a diffraction grating 1, and a plurality of grooves in a G2 zone are grooves for obtaining a diffraction grating 2. The depth of the groove in the G1 zone and the depth of the groove in the G2 zone are appropriately adjusted, for example, according to a desired diffraction charac-teristic, and may be different from each other as illustrated in the figure, for example.

Furthermore, along with this, the amount of the resist material R applied onto a substrate SB is also different between the G1 zone and the G2 zone as illustrated in the figure, and along with this, the film thickness of the resist to be formed may also be different between the G1 zone and the G2 zone.

Note that the depth of the groove in the G1 zone corresponds to the height of the diffraction grating 1, and may be, for example, 10 nm or more, 20 nm or more, or 30 nm or more. Furthermore, the depth may be, for example, 500 nm or less, 400 nm or less, or 300 nm or less.

The depth of the groove in the G2 zone corresponds to the height of the diffraction grating 2, and may be, for example, 10 nm or more, 20 nm or more, or 30 nm or more. Furthermore, the depth may be, for example, 500 nm or less, 400 nm or less, or 300 nm or less.

As illustrated in the figure, the depth of the groove in the G1 zone (that is, the height of the diffraction grating 1) may be different from the depth of the groove in the G2 zone (that is, the height of the diffraction grating 2), but may be the same. These values can be appropriately adjusted by those skilled in the art according to the required diffraction characteristics of each diffraction grating.

When the molding by the stamper ST is performed as described above, the resist material R flows, and along with this, the TZ is formed between the G1 zone and the G2 zone. FIG. 2B illustrates a schematic graph illustrating the TZ residual film thickness where the vertical axis is the residual film thickness (RLT) of the resist and the horizontal axis is the position. T1 is a resist material thickness required for the diffraction grating 1. T2 is a resist material thickness required for the diffraction grating 2. In a zone A1, thickness unevenness due to the flow of the resist material for forming the diffraction grating 1 may occur. In a zone A2, thickness unevenness due to the flow of the resist material for forming the diffraction grating 2 may occur.

As illustrated in FIG. 2B, in a case where the height of the diffraction grating is high (G1 zone), the application amount of the resist material also increases, and the residual film thickness (RLT) of the resist in the TZ also tends to become high in a part close to the G1 zone in the TZ. On the other hand, in a case where the height of the diffraction grating is low (G2 zone), the application amount of the resist material decreases, and the residual film thickness (RLT) of the resist in the TZ decreases in a part close to the G2 zone in the TZ.

In FIG. 2B, a line of Case 1 indicates an ideal flat TZ shape. However, with the diffraction grating formation method as described above, such a flat TZ is not formed due to the fluidity of the resist material and the required diffraction grating structure. For example, the TZ may have a high residual film thickness RLT, for example, as indicated by a line of Case 2.

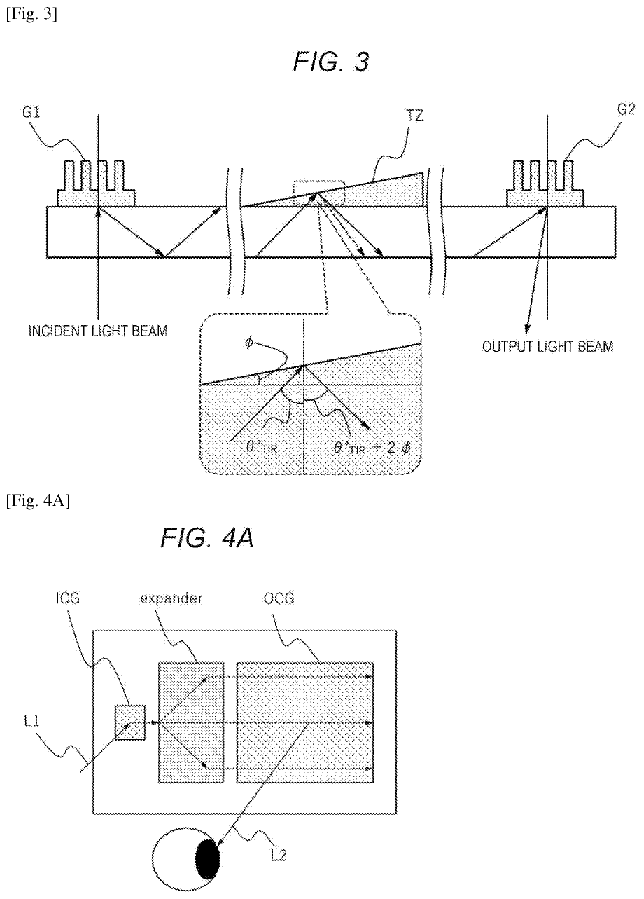

Image quality degradation due to the TZ will be described below with reference to FIG. 3. The figure is a schematic diagram of a light beam that guides the TZ. In a case where the shape in the TZ is not flat, the light guide angle of the light beam reaching the resist residual film in the TZ changes. The change in the light guide angle is 20 as illustrated in the figure. Therefore, a geometric optical modulation transfer function (MTF) degrades. MTF is one of the indices of image quality, and represents contrast at a certain spatial frequency. When the inclination (hereinafter also called “slope”) angle of the shape of the TZ is large, the change in the light guide angle of the light beam shining on the slope also becomes large. Furthermore, the area and the number of times the light beam shines on the slope vary depending on the width of the TZ, and the light beam ratio at which the light guide angle deviates also varies. Here, comparing Case 2 and Case 3 in FIG. 2B, the conventional Case 2 shape has a high TZ shape and a large slope angle, so that MTF degradation tends to be large.

The present inventors have found that the problem described above can be solved by satisfying a predetermined condition. For example, according to the present disclosure, it has been found that image quality degradation may be prevented by forming the TZ between the two diffraction gratings into a structure, also referred to herein as a transition zone structure, having a mountain shape as indicated by the line of Case 3 in FIG. 2B and performing control to satisfy a predetermined condition. Note that the mountain shape illustrated in the figure is not an actual mountain shape but is schematically illustrated for better understanding of the present disclosure.

Hereinafter, first, a definition regarding the TZ and various types of parameters used for defining the predetermined condition will be described. Next, embodiments of the present disclosure will be described.

### 1.2 Definition Regarding TZ and Various Types of Parameters

The place and shape of the TZ are described in more detail below.

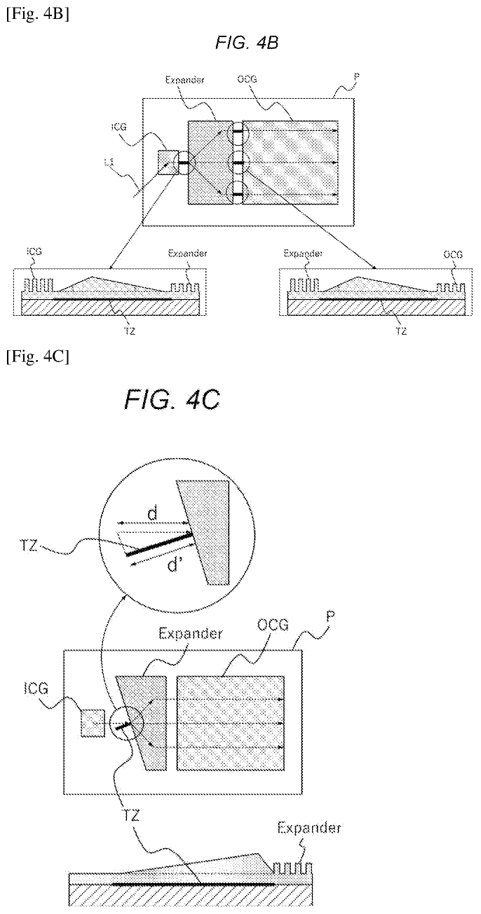

First, an incident light beam and an emission light beam that are referred to for specifying the TZ will be described with reference to FIG. 4A. As illustrated in the figure, for example, a light beam entering the ICG is called an incident light beam (solid line indicated by reference sign L1 in the figure), and a light beam emitting from the OCG is also called an emission light beam (a solid line indicated by reference sign L2 in the figure). The incident light beam is a light beam having an incident angle corresponding to a central angle of view and having a peak wavelength. The emission light beam is a light beam having the central angle of view.

Next, the place of the TZ will be described below. FIG. 4B illustrates a schematic diagram of a light guide plate provided with a diffraction grating. In the figure, the TZ exists in a circled zone. The TZ exists between two diffraction gratings provided on the light guide plate, and may be, for example, a zone between the ICG and the expander as illustrated in the lower left of the figure, or may be a zone between the expander and the OCG as illustrated in the lower right of the figure.

Furthermore, the light guide plate in the figure is provided with an expander in addition to the ICG and the OCG, but in a case where the expander is not provided, the TZ may be a zone between the ICG and the OCG.

Furthermore, there is a case where the light guide plate is provided with a diffraction grating (also called a recycler) for returning, to the diffraction grating, light traveling from each diffraction grating toward the light guide plate end part. In this case, the TZ may be a zone between each diffraction grating and the recycler.

Thus, the TZ exists between the two diffraction gratings provided on the light guide plate.

As illustrated in the figure, in a TZ zone where a light beam having a central angle of view and a peak wavelength to be used is guided, a TZ in a direction perpendicular to a grating boundary of a portion through which the light beam passes is defined as a TZ cross section.

Furthermore, there may be a case where light does not perpendicularly enter but obliquely enters the diffraction grating, such as a zone (circled zone) where light enters the expander illustrated in FIG. 4C. In this case, the TZ is cut in a cross section perpendicular to the diffraction grating as indicated by the line TZ in the circled zone.

Note that, in this case, as illustrated in the circled zone in the figure, a total reflection interval d described later is also redefined as d′.

Next, the shape of the transition zone structure (TZ) in accordance with embodiments of the present disclosure will be described.

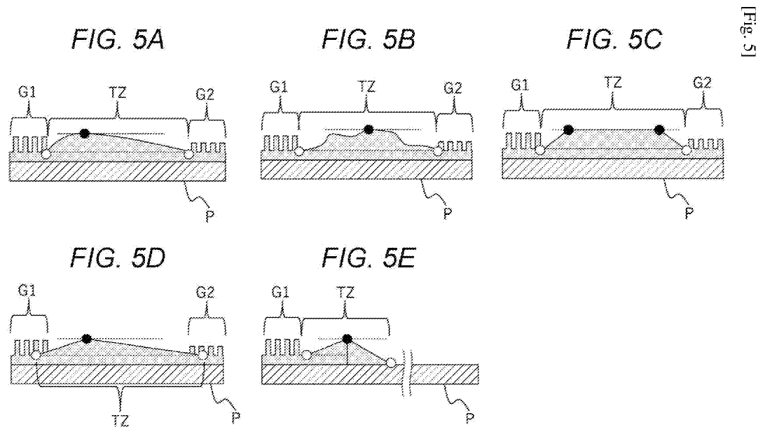

Examples of the shape of the TZ are illustrated in FIGS. 5A to 5E. G1 and G2 illustrated in FIGS. 5A to 5E are a first diffraction grating and a second diffraction grating, respectively, and the TZ is a structure having a mountain shape existing between these diffraction gratings.

As illustrated in FIG. 5A, the TZ may have a shape in which a slope is a curve. Furthermore, the TZ may be amorphous as illustrated in FIG. 5B. Furthermore, the TZ may be trapezoidal as illustrated in FIG. 5C. Furthermore, as illustrated in FIG. 5D, a part of the slope of the TZ may enter the first diffraction grating and/or the second diffraction grating. Furthermore, as illustrated in FIG. 5E, a distance between the first diffraction grating and the second diffraction grating may be long, and one end of the TZ may reach the light guide plate.

In the present description, the highest position in the TZ cross section (position farthest from the light guide plate surface) is defined as a vertex of the TZ. In each of FIGS. 5A to 5E, the vertex is indicated by a black circle.

Furthermore, in the present description, a position where the height of the TZ is the height of the resist residual film thickness (RLT) of the diffraction grating or two positions where the height of the TZ becomes zero are defined as end points of the TZ. The end point is indicated by a white circle in the figure.

In the present description, the shape formed by the vertex of the TZ and the two end points of the TZ is called a mountain shape.

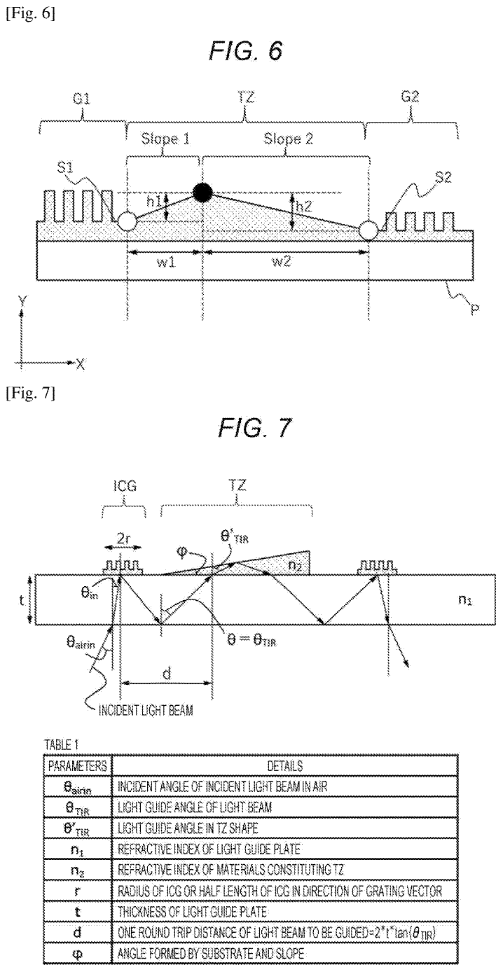

FIG. 6 is a view for explaining the definition of the shape of the TZ. In the present description, two straight lines drawn from a black circle (vertex) to a white circle (end point) are defined as a slope 1 and a slope 2, respectively. These are in no particular order.

As illustrated in the figure, a direction horizontal to the surface of the light guide plate P (particularly, the surface provided with the diffraction grating) is defined as an X-axis, and a direction perpendicular to the surface is defined as a Y-axis. Then, the lengths of the slopes 1 and 2 in the X-axis direction are defined as a width w1 of the slope 1 and a width w2 of the slope 2, respectively.

The lengths of the slopes 1 and 2 in the Y-axis direction are defined as a height h1 of the slope 1 and a height h2 of the slope 2, respectively. Furthermore, the height of each slope is a length from the reference surface of the adjacent diffraction grating to the vertex, and is not a length from the light guide plate surface to the vertex. In the figure, the height h1 of the slope 1 is a length in the Y-axis direction from a reference surface S1 to the black circle (vertex) of a first diffraction grating G1. The height h2 of the slope 2 is a length in the Y-axis direction from a reference surface S2 of a second diffraction grating G2 to the black circle (vertex).

FIG. 7 and Table 1 in FIG. 7 explain other parameters used in the present disclosure. Note that the light beam targeted by these parameters is a light beam that uses the peak wavelength of the light source and has the light guide angle closest to the critical angle among the angle-of-view light beams. This light beam is a light beam having an angle of view that is most susceptible to the influence of the TZ. Therefore, in a case where a target MTF value described later can be obtained with this light beam, the target MTF value is successfully achieved also in the entire angle of view.

### 1.3 Example 1 of Condition Regarding MTF

In one embodiment, a light guide plate unit according to the present disclosure includes: a light guide plate; and a structure having a first diffraction grating provided on one surface of the light guide plate, a second diffraction grating that diffracts light diffracted by the first diffraction grating, and a transition zone structure, also referred to herein as a structure having a mountain shape or simply as a mountain shape or a structure, existing between the first diffraction grating and the second diffraction grating, in which the light guide plate unit is configured to satisfy the following Mathematical Expression 1 when an MTF value of light immediately before entering the mountain shape in a case where a spatial frequency is 10 cycle/deg is X₁₀ and an MTF value of light immediately after passing through the mountain shape is Y₁₀-

Here, the light immediately before entering the mountain shape may mean light after being diffracted by the first diffraction grating and before entering the structure having the mountain shape. Furthermore, the light immediately after passing through the mountain shape may mean light that has passed through the structure having the mountain shape and before being diffracted by the second diffraction grating.

$$[ Math . 12 ]$$

$$0 ≦ ( 1 - {Y}_{10} / {X}_{10} ) ≦ 0.5 \qquad ( Mathematical Expression 1 )$$

Since two MTF values X₁₀ and Y₁₀ are controlled so as to satisfy Mathematical Expression 1, degradation of image quality can be prevented.

Here, the light may be a light beam whose light guide angle in the light guide plate is closest to the critical angle among the angle-of-view light beams to be used. Furthermore, the second diffraction grating may be provided on the same surface as the surface provided with the first diffraction grating among the two surfaces of the light guide plate, or may be provided on a surface on an opposite side to the surface provided with the first diffraction grating.

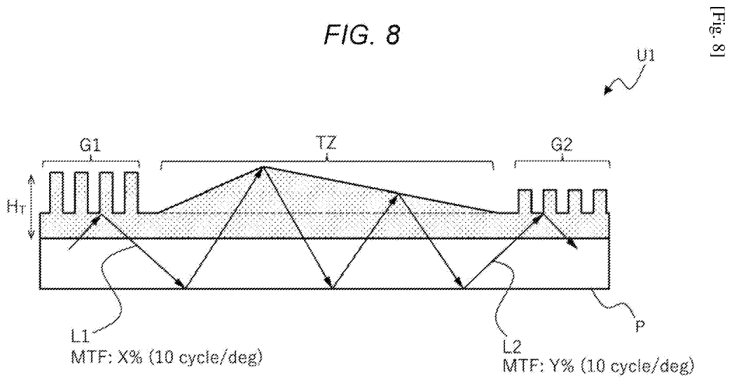

This embodiment will be described in more detail with reference to FIG. 8.

A light guide plate unit U1 of the present disclosure illustrated in the figure includes the light guide plate P, the first diffraction grating G1 provided on one surface of the light guide plate, the second diffraction grating G2 that diffracts light diffracted by the first diffraction grating, and a structure TZ having a mountain shape and existing between the first diffraction grating and the second diffraction grating, and is configured to satisfy the Mathematical Expression 1 described above.

This embodiment is particularly suitable, for example, in a case where a total height HT of the height of the first diffraction grating G1 (in particular, an incident diffraction grating configured to diffract light entering the light guide plate and cause the light to travel in the light guide plate) and the resist thickness is 150 nm or more as illustrated in the figure. That is, in the present disclosure, the total height HT of the height of the first diffraction grating G1 and the resist thickness may be preferably 150 nm or more.

In the structure having the mountain shape, for example, the first diffraction grating is formed around a diffraction grating produced by nanoimprinting with the inkjet method,

The mountain shape structure may include a material used for forming the first diffraction grating, the second diffraction grating, or both of these diffraction gratings. That is, the structure may include the material of these diffraction gratings along with the formation of these diffraction gratings.

In Mathematical Expression 1 described above, “1-Y₁₀/X₁₀” corresponds to the degradation rate of the MTF of the light beam (emission light beam L2) after reaching the TZ with respect to the MTF of the light beam (incident light beam L1) before reaching the TZ.

The spatial frequency 10 cycle/deg corresponds to approximately 0.3 of visual acuity, and is generally the lowest standard by which a human can live with naked eyes. Therefore, by satisfying the condition regarding the MTF as described above in a case where the spatial frequency is 10 cycle/deg, it is possible to achieve an image quality to an extent that even a small character can be seen.

### (MTF Measurement Method)

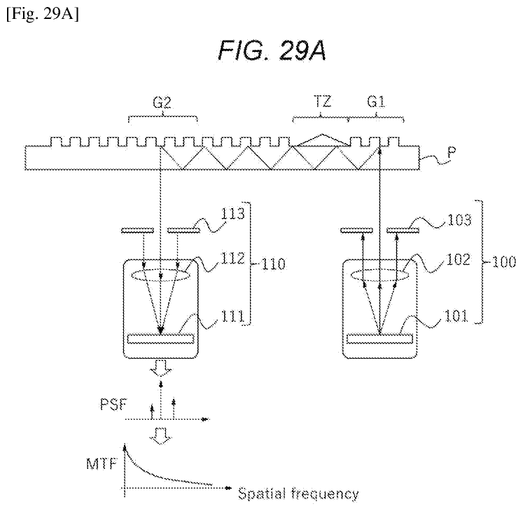

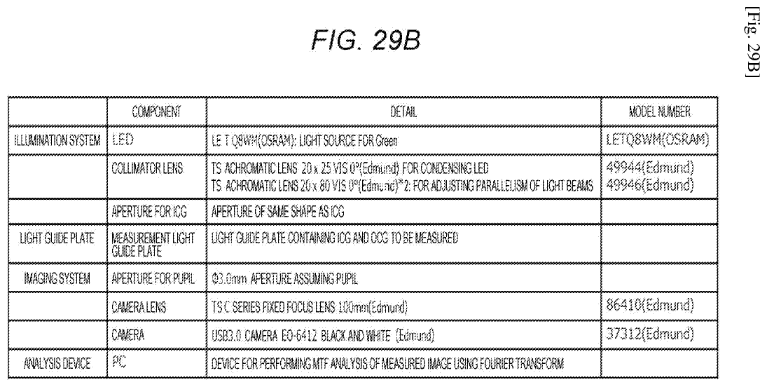

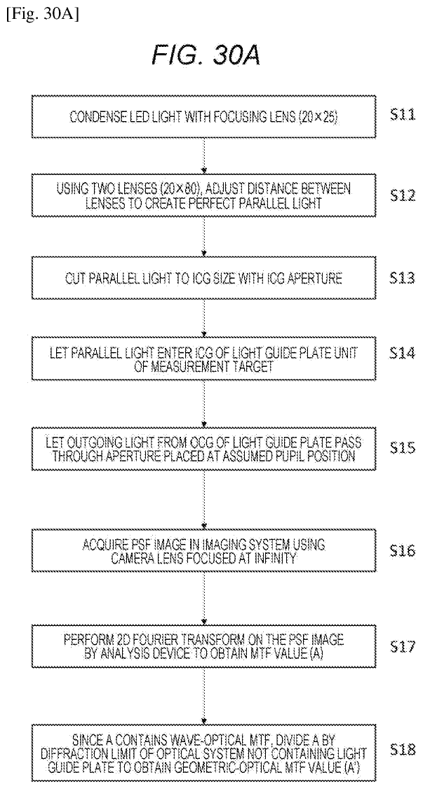

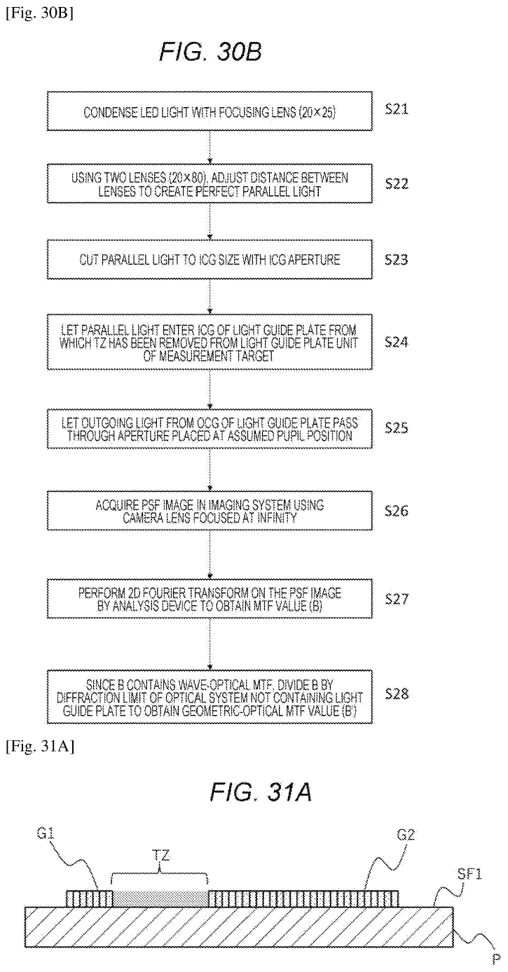

A measurement method of the MTF will be described below with reference to FIGS. 29A and 29B and FIGS. 30A and 30B. FIG. 29A illustrates the configuration of a measurement system. FIG. 29B illustrates a table describing details of components included in the measurement system.

As illustrated in FIG. 29A, the measurement system includes an illumination system 100 that causes parallel light beams to enter the light guide plate, and an imaging system 110 that detects light emitted from the light guide plate.

The illumination system 100 includes a light source (LED) 101, a collimator lens 102, and an aperture 103. Details of these components constituting the illumination system are as described in FIG. 29B.

The imaging system 110 includes an aperture 113 for pupil, a camera lens 112, and a camera 111. Details of these components constituting the imaging system are also as described in FIG. 29B.

Note that in FIG. 29B, the ICG is a diffraction grating for causing incident light to travel into the light guide plate P as described above. The OCG is a diffraction grating for emitting, from the light guide plate, light having traveled in the light guide plate P.

FIGS. 30A and 30B illustrate flowcharts of the measurement method, and the MTF degradation rate of the TZ can be acquired by executing the procedure illustrated in the flowchart.

Specifically, an MTF value (A′) is obtained by acquiring a PSF image and performing Fourier transform on the PSF image according to the flowchart illustrated in FIG. 30A for the light guide plate unit serving as a measurement target. Next, for the light guide plate unit from which the TZ (mountain shape structure) is removed, an MTF value (B′) is obtained by acquiring a PSF image and performing the Fourier transform on the PSF image according to the flowchart illustrated in FIG. 30B.

Here, (A′/B′) in a case where the spatial frequency of the PSF image is 10 cycle/deg is (Y₁₀/X₁₀) in the Mathematical Expression 1 described above.

Furthermore, (A′/B′) in a case where the spatial frequency of the PSF image is 20 cycle/deg is (Y₂₀/X₂₀) in the Mathematical Expression 5 described above described later.

Thus, in the measurement method described above, two MTF value measurements in which only the presence or absence of the TZ is changed are performed, and then the ratio is obtained with focus only on the MTF value of the final emission light. Therefore, measurement can be performed for light guide plate units of various patterns such as, not only in a case where the first diffraction grating and the second diffraction grating are an incident diffraction grating and an emission diffraction grating, respectively, but also in a case where the first diffraction grating and the second diffraction grating are the expander and the OCG, respectively.

The flowcharts illustrated in FIGS. 30A and 30B are the same except for the presence or absence of the TZ in the light guide plate unit serving as a measurement target. In the flowchart described above, main steps are as follows.

First, the parallel light beam generated by the illumination system 100 is caused to enter the light guide plate P. The parallel light beam entered reaches the ICG, is diffracted, and travels in the light guide plate. In a case where the TZ exists on the light guide plate, the traveling direction of the light beam may be changed by the TZ (S11 to S14 and S21 to S24).

Next, the light beam having traveled in the light guide plate is diffracted by the OCG and emitted out of the light guide plate. The emitted light is imaged by the imaging system 110. The imaging system 110 condenses the light beams emitted by the lens 112 and then obtains a point image distribution (PSF) image by the camera 110 (S15 and S16 and S25 and S26).

An analysis device (PC) obtains the MTF by performing two-dimensional Fourier transform on the PSF image (S17 and S18 and S27 and S28). That is, the point image distribution is converted into a spatial frequency distribution by the Fourier transform, and the MTF at a desired frequency is acquired. The analysis device is only required to be anything that can perform two-dimensional Fourier transform on the PSF image, and an information processing device (for example, a general-purpose computer) generally used in the technical field may be used. Python is used as software for executing the Fourier transform.

When the value of the MTF of the light guide plate unit (unit including the light guide plate, the diffraction grating, and the TZ (mountain shape structure)) is A′, and the value of the MTF of the light guide plate unit from which the TZ has been removed is B′, the MTF degradation rate of the TZ can be derived by 1−(A′/B′).

### (Surface on Which First Diffraction Grating, Second Diffraction Grating, and Mountain Shape Structure Exist)

The first diffraction grating and the second diffraction grating may be two diffraction gratings existing on the light guide plate and arranged so as to sandwich the TZ.

The first diffraction grating and the second diffraction grating may exist on the same surface of the light guide plate, or the first diffraction grating may exist on one surface of the light guide plate and the second diffraction grating may exist on the other surface of the light guide plate.

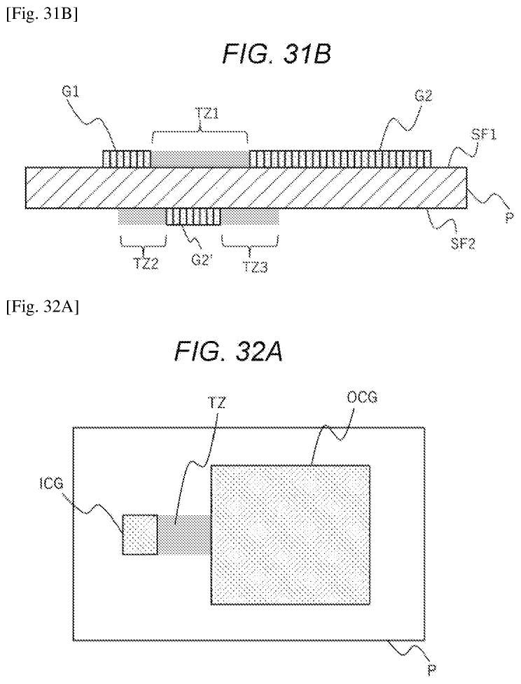

In any case, MTF degradation can be suppressed according to the present disclosure. A surface on which these diffraction gratings exist will be described with reference to FIGS. 31A and 31B.

As illustrated in FIG. 31A, the first diffraction grating G1 and the second diffraction grating G2 may exist on one surface SF1 of the light guide plate P. Then, the zone TZ where the mountain shape structure exists may exist between these two diffraction gratings. According to the present disclosure, MTF degradation caused by the mountain shape structure may be suppressed.

Furthermore, as illustrated in FIG. 31B, the first diffraction grating G1 may exist on one surface SF1 of the light guide plate P, and a second diffraction grating G2′ may exist on the other surface SF2. Then, a zone TZ2 where the mountain shape structure exists may exist between these two diffraction gratings.

Furthermore, in a case where the second diffraction grating G2 further exists on the surface SF1, a zone TZ3 in which the mountain shape structure exists may exist between the second diffraction grating G2′ and the second diffraction grating G2. In this case, either of the diffraction gratings G2 and G2′ may be treated as the first diffraction grating.

Moreover, in this case, a zone TZ1 in which the mountain shape structure exists may exist between the first diffraction grating G1 and the second diffraction grating G2 existing on the surface SF1.

According to the present disclosure, MTF degradation caused by at least one of these mountain shape structures may be suppressed.

Thus, according to the present disclosure, MTF degradation caused by the mountain shape structure existing between any two diffraction gratings provided on the light guide plate may be suppressed.

### (Diffraction Characteristics of First Diffraction Grating and Second Diffraction Grating)

The first diffraction grating and the second diffraction grating may be any two of the ICG, the expander, the OCG, and the recycler described above. That is, the first diffraction grating may have diffraction characteristics as an ICG, an expander, an OCG, or a recycler. Furthermore, the second diffraction grating may also have diffraction characteristics as an ICG, an expander, an OCG, or a recycler. The light guide plate unit of the present disclosure may include two or more diffraction gratings including the first diffraction grating and the second diffraction grating, and diffraction characteristics of each diffraction grating may be appropriately selected by those skilled in the art of light, for example.

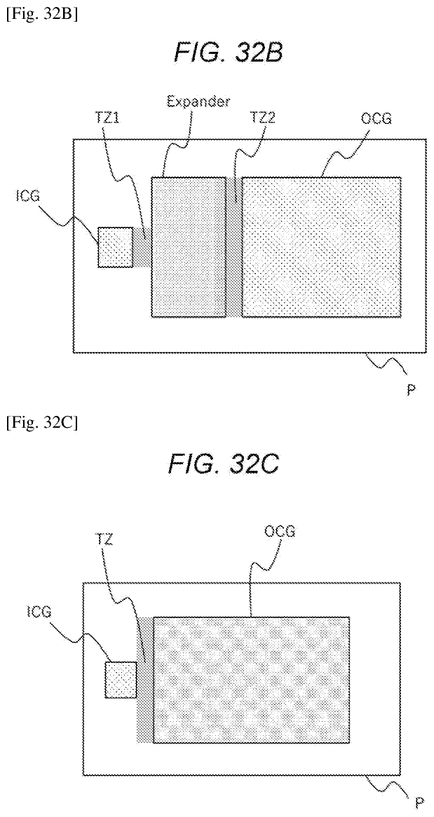

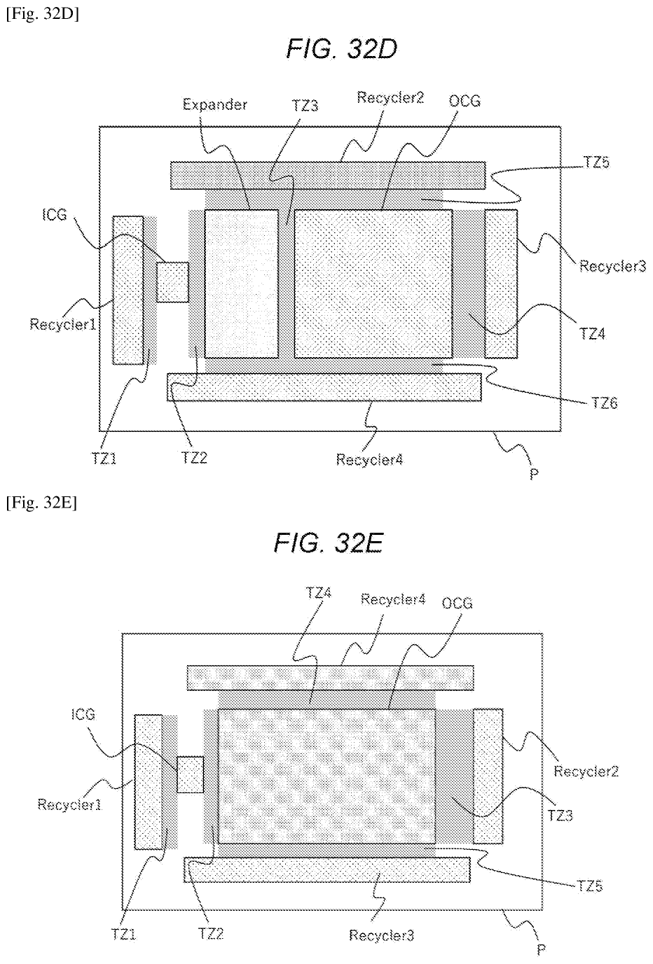

Thus, the light guide plate unit according to the present disclosure may be provided with two or more diffraction gratings including the first diffraction grating and the second diffraction grating, and the diffraction characteristics and arrangement of these diffraction gratings may be appropriately selected by those skilled in the art. Then, MTF degradation caused by the TZ existing between the two diffraction gratings may be suppressed according to the present disclosure. Hereinafter, examples of the arrangement of these diffraction gratings will be described with reference to FIGS. 32A to 32E. These figures are views illustrating schematic examples of a surface of the light guide plate unit, and illustrate configuration examples of the diffraction grating.

In FIG. 32A, the light guide plate P is provided with an ICG as the first diffraction grating and is provided with an OCG as the second diffraction grating. A mountain shape structure may exist in a gray zone TZ between these diffraction gratings. In the present disclosure, MTF degradation caused by the mountain shape structure existing in TZ1 between these may be suppressed.

Thus, the first diffraction grating is an incident diffraction grating configured to diffract light entering the light guide plate and cause the light to travel in the light guide plate, and
the second diffraction grating may be an emission diffraction grating configured to emit, from the light guide plate, light having traveled in the light guide plate. Furthermore, the OCG may have diffraction characteristics as an expander. That is, the emission diffraction grating may be an emission diffraction grating configured to expand light having traveled in the light guide plate and emit the light from the light guide plate.

In FIG. 32B, the light guide plate P is provided with the ICG, the expander, and the OCG. A mountain shape structure may exist in the gray zone TZ1 between the ICG and the expander, or a mountain shape structure may exist in a gray zone TZ2 between the expander and the OCG, or mountain shape structures may exist in both the zones TZ1 and TZ2.

In the present disclosure, the ICG may be regarded as the first diffraction grating, and the expander may be regarded as the second diffraction grating. Then, according to the present disclosure, MTF degradation caused by the mountain shape structure existing in the TZ1 between these may be suppressed.

In the present disclosure, the expander may be regarded as the first diffraction grating, and the OCG may be regarded as the second diffraction grating. Then, according to the present disclosure, MTF degradation caused by the mountain shape structure existing in the TZ2 between these may be suppressed.

Thus, in the present disclosure, the first diffraction grating is an incident diffraction grating configured to diffract light entering the light guide plate and cause the light to travel in the light guide plate, and
the second diffraction grating may be an expander configured to expand the light diffracted by the first diffraction grating and having traveled in the light guide plate.

Furthermore, the first diffraction grating is an expander configured to expand light having traveled in the light guide plate, and
the second diffraction grating may be an emission diffraction grating configured to emit, from the light guide plate, light expanded by the expander.

In FIG. 32C, the light guide plate P is provided with an ICG as the first diffraction grating and an OCG as the second diffraction grating. The ICG also has diffraction characteristics as an expander. A mountain shape structure may exist in a gray zone TZ between these diffraction gratings. In this case, the zone where the mountain shape structure exists may be larger than that in the case in FIG. 32A.

In the present disclosure, MTF degradation caused by the mountain shape structure existing in the TZ between these may be suppressed.

That is, the first diffraction grating may be an incident diffraction grating configured to diffract light entering the light guide plate to cause the light to travel in the light guide plate, and to expand the light to cause the light to travel in the light guide plate.

FIG. 32D illustrates a configuration example in which a recycler is arranged around the diffraction grating in the configuration example of FIG. 32B. The light guide plate P is provided with an ICG, an expander, and an OCG. The light guide plate P is further provided with a recycler 1 for returning, to the ICG, light traveling from the ICG to the end (left end in the figure) of the light guide plate, a recycler 2 for returning, to the expander or the OCG, light traveling from the expander or the OCG to the end (upper end in the figure) of the light guide plate, a recycler 3 for returning, to the OCG, light traveling from the OCG to the end (right end in the figure) of the light guide plate, and a recycler 4 for returning, to the expander or the OCG, light traveling from the expander or the OCG to the end (lower end in the figure) of the light guide plate.

A mountain shape structure may exist in one or more of the gray zones TZ1 to 6 between two adjacent diffraction gratings of these diffraction gratings.

In the present disclosure, MTF degradation caused by the mountain shape structure existing in the TZ between these may be suppressed.

FIG. 32E illustrates a configuration example in which a recycler is arranged around the diffraction grating in the configuration example of FIG. 32C. The light guide plate P is provided with an ICG and an OCG. The ICG also has diffraction characteristics as an expander. The light guide plate P is further provided with the recycler 1 for returning, to the ICG, light traveling from the ICG to the end (left end in the figure) of the light guide plate, the recycler 2 for returning, to the OCG, light traveling from the OCG to the end (upper end in the figure) of the light guide plate, the recycler 3 for returning, to the OCG, light traveling from the OCG to the end (right end in the figure) of the light guide plate, and the recycler 4 for returning, to the OCG, light traveling from the OCG to the end (lower end in the figure) of the light guide plate.

A mountain shape structure may exist in one or more of the gray zones TZ1 to 5 between two adjacent diffraction gratings of these diffraction gratings.

In the present disclosure, MTF degradation caused by the mountain shape structure existing in the TZ between these may be suppressed.

As illustrated in FIGS. 32D and 32E, the first diffraction grating is any diffraction grating of an incident diffraction grating configured to diffract light entering the light guide plate and cause the light to travel in the light guide plate, an expander configured to expand the light having traveled in the light guide plate, and an emission diffraction grating configured to emit the light from the light guide plate, and the second diffraction grating may be a recycler that diffracts light passing through the first diffraction grating and traveling toward an end of the light guide plate and causes the light to travel to the first diffraction grating again.

### 1.3.1 Example of Specification of Slope

In a preferred embodiment, in a case where “a width of a slope of the mountain shape” is less than “a total reflection interval of the light in the light guide plate”, “the slope” may be configured in such a manner that “a width of the slope” is equal to or less than “a threshold specified on the basis of the total reflection interval”, and in a case where “a width of a slope of the mountain shape” is equal to or greater than “a total reflection interval of the light in the light guide plate”, “the slope” may be configured in such a manner that “a height of the slope” is equal to or less than “a threshold specified on the basis of a width of the slope and an inclination angle of the slope”.

The mountain shape has two slopes. Preferably, in a case where one slope of the two slopes is focused, the slope is configured in such a manner that the width of the slope or the height of the slope becomes equal to or less than a predetermined threshold according to the relationship between the width of the one slope and the total reflection interval of the light beam traveling in the light guide plate. Thus, by changing the configuration of the slope according to the width of the slope and the total reflection interval, the MTF described above is easily satisfied, and MTF degradation is easily prevented.

In the present description, the total reflection interval is a distance specified as described in FIG. 7 regarding the light beam having the peak wavelength of a light source spectrum of light entering the light guide plate.

In order to make this embodiment easier to understand, deviation of the light beam angle caused by one slope will be described below, and next the relationship among the TZ shape, the PSF, and the MTF will be described. Thereafter, a more specific embodiment will be described.

### 1.3.2 Deviation of Light Beam Angle Caused by One Slope

As illustrated in FIG. 7, a light beam having an angle of θₐᵢᵣᵢₙ enters the light guide plate from the air, and then the light beam is taken into the light guide plate by the ICG and propagates. At that time, it is assumed that the light beam shines on the TZ once, that is, the angle of the light beam emitted from the OCG to the pupil side becomes θₐᵢᵣᵢₙ+Δpeak. The Δpeak can be obtained from the grating mathematical expression and Snell's law as follows.

$$Δ peak = φ * ( 2 * {n}_{2} * cos ( {θ}_{TIR}^{′} ) ) / cos ( {θ}_{airin} )$$

Here, φ is an angle between the substrate and the slope of the TZ. θₐᵢᵣᵢₙ is an incident angle in air. n₂ is a refractive index of the TZ. θ′_{TIR} is a light guide angle in the TZ. That is, the deviation amount of the light beam angle and the angle of the slope are in a proportional relationship.

1.3.3 Relationship among TZ Shape, PSF, and MTF

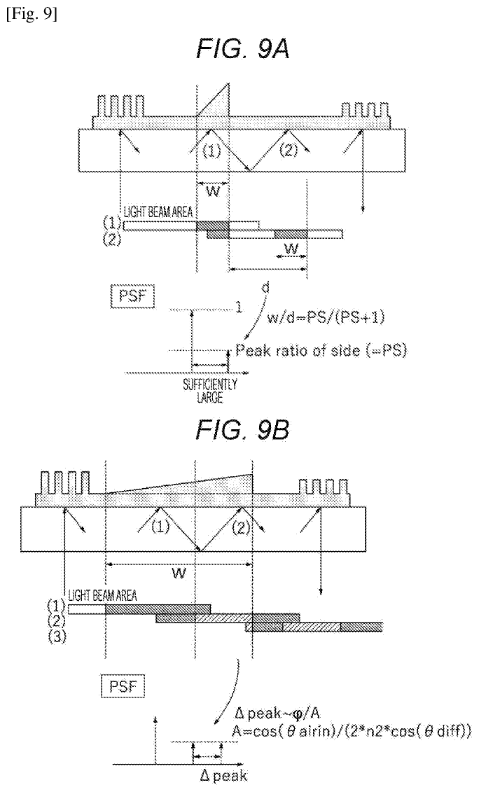

FIGS. 9A and 9B illustrate schematic diagrams in a one-dimensional direction for explaining the relationship among the TZ shape, the PSF, and the MTF.

A case where the slope width of the TZ can be reduced will be described with reference to FIG. 9A. That is, a case where a slope width w of the TZ is smaller than the total reflection interval d of the light beam in the light guide plate will be described.

Since the slope width is smaller than the total reflection interval, the light beam surface has a portion where the light beam shines on the slope and a portion where the light beam does not shine on the slope, and the light beam ratio of the light beam that shines on the slope becomes the light beam ratio at which the angle is deviated as it is. The ratio of the width corresponding to the slope in the light beam surface is expressed by w/d. The number of times the light beam shines on the slope on the light beam surface is once. Furthermore, as described above, the angle of the slope affects the deviation amount of the light beam angle.

Considering the point spread function (PSF), in a case where the total light amount is 1, a PSF image has the light beam angle not deviated for the light amount of 1-w/d but the light beam angle deviated for the light amount of w/d. The geometric optical MTF can be calculated from this PSF image. Therefore, in order to achieve the target MTF value for an optional slope angle, w/d is only required to be controlled.

Here, the PSF is a point image distribution, and when light beams having different angles exist in a light beam at the time of condensing the light beam into one point, an image having not one point but a plurality of points is obtained, and the dispersion of the angles in the light beam is also known by the dispersion of the points.

A case where the slope width of the TZ is large will be described with reference to the right of the figure. That is, a case where a slope width w of the TZ is larger than the total reflection interval d of the light beam in the light guide plate will be described. Since the slope width is large, the light beam shines on the slope on the entire light beam surface, and the light beam surface has a portion where the light beam shines on the slope n (=1, 2, 3, . . . ) times and a portion where the light beam shines on the slope n+1 times. Since the entire light beam shines on the slope n times or more, the light beam angle is changed from the original light beam angle, and therefore there is image distortion. However, image blurring (MTF) is affected by an angle difference in the light beam surface, and therefore it is an effect for one slope.

Considering the PSF, since the angle deviation amount for one slope can be expressed by Δpeak described above, the angle deviation amount (that is, Δpeak) is only required to be controlled in order to achieve the target MTF value for an optional slope width.

Based on the above, a specific slope configuration example for preventing MTF degradation will be described below.

### 1.4 Configuration Example 1 of Slope

The mountain shape of the TZ has two slopes. Therefore, for example, in the light guide plate unit of the present disclosure, the slope may be specified for each case of the three cases as followings.

### 1.4.1 Configuration Example 1-1 (Case Where Both Widths of Two Slopes are Large)

A case where the both widths of the two slopes are large will be described below. This case corresponds to a case where both the slope widths w1 and w2 of the TZ are equal to or greater than the total reflection interval d of the light beam in the light guide plate.

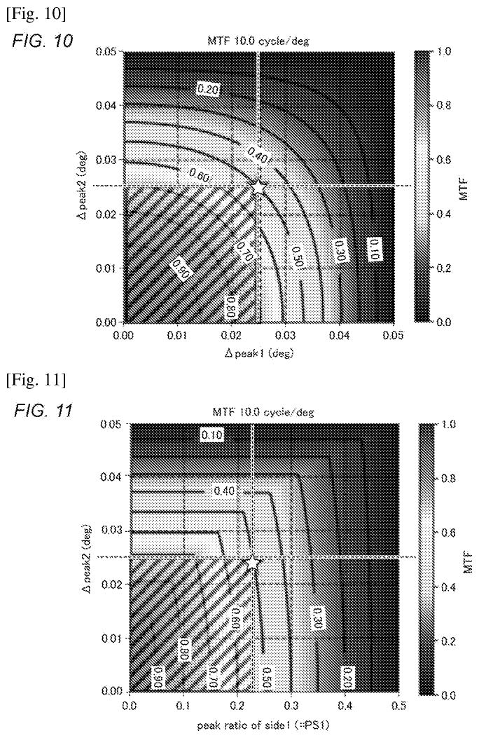

In this case, FIG. 10 illustrates the distribution of the MTF value in a case where the light beam angle deviation amount Δpeak due to each of the two slopes is represented by the vertical and horizontal axes. The horizontal axis and the vertical axis represent the light beam angle deviation amount Δpeak changed by the slope 1 and the slope 2, respectively.

In the figure, a preferable TZ shape is expressed as the following Mathematical Expression 2 on the basis of the range of Δpeak (zone of the shaded part illustrated in FIG. 10) where the degradation rate of the MTF at the spatial frequency of 10 cycle/deg becomes 50% or less (that is, satisfies Mathematical Expression 1).

$$\begin{matrix}[ Math . 13 ] & \\ \begin{matrix}0 < h 1 ≦ w 1 * tan ( 0.025 [ deg ] * A ) \\ and \\ 0 < h 2 ≦ w 2 * tan ( 0.025 [ deg ] * A )\end{matrix} \} & ( Mathematical Expression 2 )\end{matrix}$$

where, in Mathematical Expression 2,
h1=(height from reference surface of the first diffraction grating to vertex of the mountain shape)
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape).

Since the constraint of the TZ shape by Mathematical Expression 2 strongly restricts h1 and h2 described above with reference to FIGS. 7, w1 and w2 are allowed even if they are large. That is, even if w cannot be controlled, h is only required to be restricted.

For example, assuming that θₐᵢᵣᵢₙ=25 [deg], n₁=2.0, n₂=1.5, Λ (ICG pitch)=360 nm, and λ (peak wavelength)=530 nm, 0<h1≤92 nm is established in a case of w₁ (or w₂)=0.5 mm.

### 1.4.2 Configuration Example 1-2 (Case Where Width of One Slope is Large and Width of Other Slope is Small)

An example in which one slope width is small but the other slope width is large will be described below. This case corresponds to a case where the slope width w1 of the TZ is less than the total reflection interval d of the light beam in the light guide plate, and the slope width w2 of the TZ is equal to or greater than the total reflection interval d of the light beam in the light guide plate.

In this case, FIG. 11 illustrates the distribution of the MTF value in a case where the light beam angle deviation amount Δpeak due to one slope is represented by the vertical axis, and the light beam ratio PS at which the angle is deviated due to the other slope is represented by the horizontal axis.

In the figure, a preferable TZ shape is expressed as the following Mathematical Expression 3 on the basis of the ranges of PS and Δpeak (zone of the shaded part illustrated in FIG. 11) where the degradation rate of the MTF at the spatial frequency of 10 cycle/deg becomes 50% or less (that is, satisfies Mathematical Expression 1).

$$\begin{matrix}[ Math . 14 ] & \\ \begin{matrix}0 < w 1 ≦ 0.23 * d \\ and \\ 0 < h 2 ≦ w 2 * tan ( 0.025 [ deg ] * A )\end{matrix} \} & ( Mathematical Expression 3 )\end{matrix}$$

where, in Mathematical Expression 3,
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape).

The feature of this Mathematical Expression is that it is an effective constraint condition when the width of the slope on one side in FIG. 7 can be strongly restricted.

For example, assuming that θₐᵢᵣᵢₙ=25 [deg], n₁=2.0, n₂=1.5, Λ (ICG pitch)=360 nm, λ (peak wavelength)=530 nm, and t=0.5 mm, d=0.6 mm and 0<w1≤0.14 mm are established.

### 1.4.3 Configuration Example 1-3 (Case Where Both Widths of Two Slopes are Small)

An example of a case where the widths of the two slopes are small will be described below. This case corresponds to a case where both the slope widths w1 and w2 of the TZ are less than the total reflection interval d of the light beam in the light guide plate.

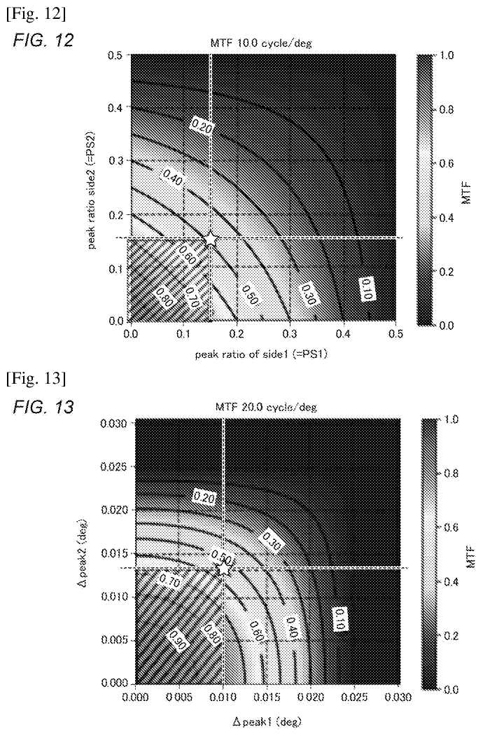

In this case, FIG. 12 illustrates the distribution of the MTF value in a case where the light beam ratio PS at which the angle due to each slope of the two slopes is deviated represented by the vertical and horizontal axes. The horizontal axis and the vertical axis represent the light beam ratios PS at which the angles changed by the slope 1 and the slope 2, respectively, are deviated.

In the figure, a preferable TZ shape is expressed as the following Mathematical Expression 4 on the basis of the range of PS where the degradation rate of the MTF at the spatial frequency of 10 cycle/deg becomes 50% or less (that is, satisfies Mathematical Expression 1).

$$\begin{matrix}[ Math . 15 ] & \\ \begin{matrix}0 < w 1 ≦ 0.15 * d \\ and \\ 0 < w 2 ≦ 0.15 * d\end{matrix} \} & ( Mathematical Expression 4 )\end{matrix}$$

where, in Mathematical Expression 4,
w1=(width of slope 1)
w2=(width of slope 2).

The feature is a constraint condition effective when the widths of the slopes on both sides in FIG. 7 can be strongly restricted.

For example, assuming that θₐᵢᵣᵢₙ=25 [deg], n₁=2.0, n₂=1.5, Λ (ICG pitch)=360 nm, λ (peak wavelength)=530 nm, and t=0.5 mm, d=0.6 mm and 0<w1 and w2≤0.090 mm are established.

As described in the above configuration examples 1-1 to 1-3, MTF degradation can be prevented by controlling the width or the height of each slope according to the magnitude relationship between the width of the slope of the mountain shape structure of the TZ and the total reflection interval.

That is, in a preferred embodiment,
in a case where “a width of a slope of the mountain shape” is less than “a total reflection interval of the light in the light guide plate”, “the slope” may be configured in such a manner that “a width of the slope” is equal to or less than “a threshold specified on the basis of the total reflection interval”, and
in a case where “a width of a slope of the mountain shape” is equal to or greater than “a total reflection interval of the light in the light guide plate”, “the slope” may be configured in such a manner that “a height of the slope” is equal to or less than “a threshold specified on the basis of a width of the slope and an inclination angle of the slope”.

More specifically, the light guide plate unit of the present disclosure may be configured in such a manner that the width or the height of the two slopes in the mountain shape satisfies any of the Mathematical Expressions 2 to 4 described above according to the magnitude relationship between the width of each slope and the total reflection interval.

### 1.5 Example 2 of Condition Regarding MTF

In 1.3 described above, Mathematical Expression 1 regarding a case where the spatial frequency is 10 cycle/deg has been described, and then in 1.4 described above, an example of the mountain shape structure (TZ) configured to satisfy Mathematical Expression 1 has been described.

In the present disclosure, more preferably, the light guide plate unit of the present disclosure may be configured in such a manner that the MTF value in a case where the spatial frequency is 20 cycle/deg satisfies a predetermined condition.

That is, in a more preferred embodiment, a light guide plate unit according to the present disclosure includes: a light guide plate; and a structure having a first diffraction grating provided on one surface of the light guide plate, a second diffraction grating that diffracts light diffracted by the first diffraction grating, and a mountain shape existing between the first diffraction grating and the second diffraction grating, in which the light guide plate unit is configured to satisfy the following Mathematical Expression 5 when an MTF value of light immediately before entering the mountain shape in a case where a spatial frequency is 20 cycle/deg is X₂₀ and an MTF value of light immediately after passing through the mountain shape is Y₂₀.

$$\begin{matrix}[ Math . 16 ] & \\ 0 ≦ ( 1 - {Y}_{20} / {X}_{20} ) ≦ 0.5 & ( Mathematical Expression 5 )\end{matrix}$$

Since the two MTF values X₂₀ and Y₂₀ are controlled so as to satisfy Mathematical Expression 5, degradation of image quality can be prevented.

Here, the light may be a light beam whose light guide angle in the light guide plate is closest to the critical angle among the angle-of-view light beams to be used.

### 1.6 Configuration Example 2 of Slope

Also in the case where the spatial frequency is 20 cycle/deg, similarly to the case where the spatial frequency is 10 cycle/deg, for example, in the light guide plate unit of the present disclosure, the slope may be specified for each case of the three cases as followings.

### 1.6.1 Configuration Example 2-1 (Case Where Widths of Two Slopes are Large)

A case where the both widths of the two slopes are large will be described below. This case corresponds to a case where both the slope widths w1 and w2 of the TZ are equal to or greater than the total reflection interval d of the light beam in the light guide plate.

In this case, FIG. 13 illustrates the distribution of the MTF value in a case where the light beam angle deviation amount Δpeak due to each of the two slopes is represented by the vertical and horizontal axes. The horizontal axis and the vertical axis represent the light beam angle deviation amount Δpeak changed by the slope 1 and the slope 2, respectively.

In the figure, the shape of the TZ obtained from the range of Δpeak where the degradation rate of the MTF at the spatial frequency of 20 cycle/deg becomes 50% or less (that is, satisfies Mathematical Expression 5) is expressed as the following Mathematical Expression 6.

$$\begin{matrix}[ Math . 17 ] & \\ \begin{matrix}0 < h 1 ≦ w 1 * tan ( 0.0125 [ deg ] * A ) \\ and \\ 0 < h 2 ≦ w 2 * tan ( 0.0125 [ deg ] * A )\end{matrix} \} & ( Mathematical Expression 6 )\end{matrix}$$

where, in Mathematical Expression 6,
h1=(height from reference surface of the first diffraction grating to vertex of the mountain shape)
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape).

Since the constraint of the TZ shape by Mathematical Expression 6 strongly restricts h1 and h2 described above with reference to FIGS. 7, w1 and w2 are allowed even if they are large. That is, even if w cannot be controlled, h is only required to be restricted.

For example, assuming that θₐᵢᵣᵢₙ=25 [deg], n₁=2.0, n₂=1.5, Λ (ICG pitch)=360 nm, and λ (peak wavelength)=530 nm, 0<h1≤92 nm is established in a case of w1 (or w2)=0.5 mm.

### 1.6.2 Configuration Example 2-2 (Case Where Width of One Slope is Large and Width of Other Slope is Small)

An example in which one slope width is small but the other slope width is large will be described below. This case corresponds to a case where the slope width w1 of the TZ is less than the total reflection interval d of the light beam in the light guide plate, and the slope width w2 of the TZ is equal to or greater than the total reflection interval d of the light beam in the light guide plate.

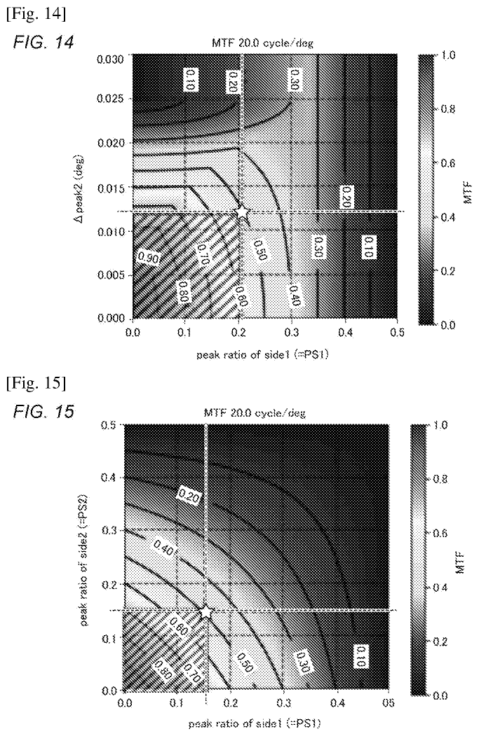

In this case, FIG. 14 illustrates the distribution of the MTF value in a case where the light beam angle deviation amount Δpeak due to one slope is represented by the vertical axis, and the light beam ratio PS at which the angle is deviated due to the other slope is represented by the horizontal axis.

In the figure, the shape of the TZ obtained from the ranges of the PS and Δpeak where the degradation rate of the MTF at the spatial frequency of 20 cycle/deg becomes 50% or less (that is, satisfies Mathematical Expression 5) is expressed as the following Mathematical Expression 7.

$$\begin{matrix}[ Math . 18 ] & \\ \begin{matrix}0 < w 1 ≦ 0.2 * d \\ and \\ 0 < h 2 ≦ w 2 * tan ( 0.0125 [ deg ] * A )\end{matrix} \} & ( Mathematical Expression 7 )\end{matrix}$$

where, in Mathematical Expression 7,
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape).

The feature of this Mathematical Expression is that it is an effective constraint condition when the width of the slope on one side in FIG. 7 can be strongly restricted.

For example, assuming that θₐᵢᵣᵢₙ=25 [deg], n₁=2.0, n₂=1.5, Λ (ICG pitch)=360 nm, λ (peak wavelength)=530 nm, and t=0.5 mm, d=0.6 mm and 0<w1≤0.12 mm are established.

### 1.6.3 Configuration Example 2-3 (Case Where Widths of Two Slopes are Small)

An example of a case where the widths of the two slopes are small will be described below. This case corresponds to a case where both the slope widths w1 and w2 of the TZ are less than the total reflection interval d of the light beam in the light guide plate.

In this case, FIG. 15 illustrates the distribution of the MTF value in a case where the light beam ratio PS at which the angle due to each slope of the two slopes is deviated represented by the vertical and horizontal axes. The horizontal axis and the vertical axis represent the light beam ratios PS at which the angles changed by the slope 1 and the slope 2, respectively, are deviated.

In the figure, the shape of the TZ obtained from the range of the PS where the degradation rate of the MTF at the spatial frequency of 20 cycle/deg becomes 50% or less (that is, satisfies Mathematical Expression 5) is expressed as the following Mathematical Expression 8.

$$\begin{matrix}[ Math . 19 ] & \\ \begin{matrix}0 < w 1 ≦ 0.15 * d \\ and \\ 0 < w 2 ≦ 0.15 * d\end{matrix} \} & ( Mathematical Expression 8 )\end{matrix}$$

where, in Mathematical Expression 8,
w1=(width of slope 1)
w2=(width of slope 2).

The feature of this Mathematical Expression is that it is an effective constraint condition when the widths of the slopes on both sides in FIG. 7 can be strongly restricted.

For example, assuming that θₐᵢᵣᵢₙ=25 [deg], n₁=2.0, n₂=1.5, Λ (ICG pitch)=360 nm, λ (peak wavelength)=530 nm, and t=0.5 mm, d=0.6 mm and 0<w1 and w2≤ 0.090 mm are established.

As described in the above configuration examples 2-1 to 2-3, MTF degradation can be prevented by controlling the width or the height of each slope according to the magnitude relationship between the width of the slope of the mountain shape structure of the TZ and the total reflection interval.

That is, in a preferred embodiment,
in a case where “a width of a slope of the mountain shape” is less than “a total reflection interval of the light in the light guide plate”, “the slope” may be configured in such a manner that “a width of the slope” is equal to or less than “a threshold specified on the basis of the total reflection interval”, and
in a case where “a width of a slope of the mountain shape” is equal to or greater than “a total reflection interval of the light in the light guide plate”, “the slope” may be configured in such a manner that “a height of the slope” is equal to or less than “a threshold specified on the basis of a width of the slope and an inclination angle of the slope”.

More specifically, the light guide plate unit of the present disclosure may be configured in such a manner that the width or the height of the two slopes in the mountain shape satisfies any of the Mathematical Expressions 6 to 8 described above according to the magnitude relationship between the width of each slope and the total reflection interval.

### 1.7 Configuration Example of the TZc

In the light guide plate unit of the present disclosure, a surface on an opposite side to or on the same side as the surface provided with the mountain shape structure (hereinafter, also called the first structure or TZ) of the two surfaces of the light guide plate may be provided with a structure (hereinafter, also called the second structure or TZc) for canceling the influence of the mountain shape structure.

That is, the light guide plate unit according to the present disclosure may be configured in such a manner that the light beam whose angle is changed by the TZ shines on the TZc. The angle deviation of the light beam is canceled by the TZc. Various embodiments can be adopted depending on the shape of the TZ and the in-stallation position of the TZc.

Also the light guide plate unit having such a configuration can eliminate MTF degradation, can satisfy the condition of Mathematical Expression 1 described above, and further satisfy the condition of Mathematical Expression 5.

Hereinafter, an example of a light guide plate unit having these two structures will be described.

### 1.7.1 Example 1 of TZc Existing on Surface on Opposite Side to Surface where TZ Exists

In one embodiment, the surface on the opposite side to the surface provided with the TZ of the two surfaces of the light guide plate may be provided with the TZc. After the light beam traveling in the light guide plate shines on the TZ and the light beam angle changes, the light beam shines on TZc, whereby the light beam angle can be returned to the light guide angle before shining on the TZ.

In this case, the TZ and the TZc may preferably include the same material. Therefore, it becomes easy to cancel the angle deviation of the light beam.

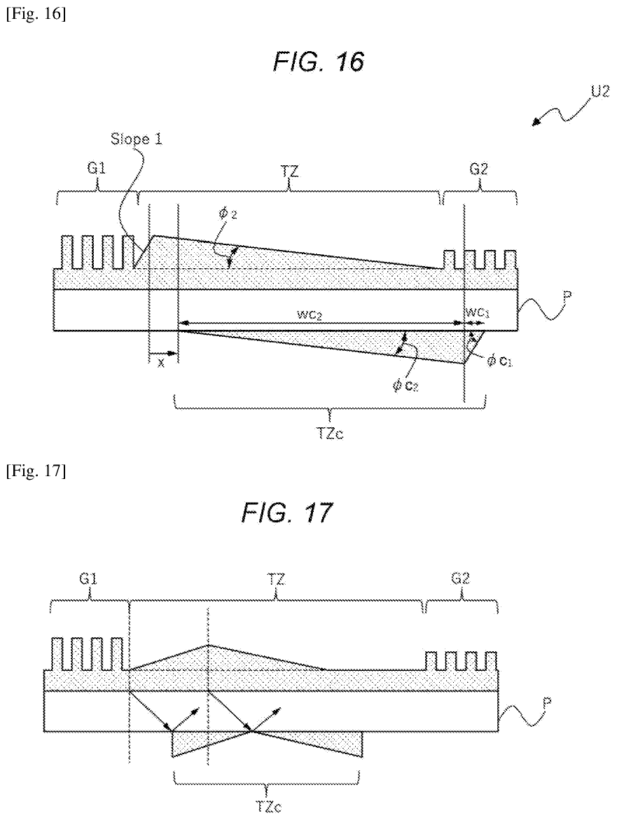

For example, as illustrated in FIG. 16, the TZ may exist on one of the two surfaces of the light guide plate P, and then the TZc may be provided on the other surface. The TZc may have substantially the same shape as that of the TZ. The TZc may be arranged to be point-symmetric with the TZ with respect to the substrate cross section.

A light guide plate unit U2 illustrated in the figure includes the light guide plate P, the first diffraction grating G1 provided on one surface of the light guide plate, the second diffraction grating G2 that diffracts light diffracted by the first diffraction grating, and the first structure TZ having a mountain shape and existing between the first diffraction grating and the second diffraction grating. Moreover, the one surface or the other surface of the light guide plate includes the second structure TZc having a mountain shape configured to cancel the angle deviation of the light due to the first structure TZ.

Regarding this embodiment, the shapes of the TZ and the TZc will be described.

First, the shape of the TZ will be described.

Regarding the shape of the TZ, preferably, the width w1 of the slope 1 satisfies w1<0.1*d, and the width of the slope 2 satisfies w2≥d. Here, d is the total reflection interval of the light in the light guide plate.

In order to cancel the influence of the TZ on the light beam, it is desirable to arrange the slope of the TZc corresponding to each slope of the TZ. As illustrated in FIG. 17, in a case where the slope width is large, the shape of the TZc may be required to have a valley shape and a perpendicular side surface, and it is difficult to achieve this shape. Therefore, by satisfying w1<0.1*d as described above, it becomes easy to form the TZc.

Furthermore, in a case where w1<0.1*d is satisfied, the influence of one slope (slope of w1) is so very small that there is also an advantage that it is only required to cancel only the influence of the other slope.

That is, the light guide plate unit may be configured in such a manner that the width w1 of the slope 1 on the first diffraction grating side of the first structure satisfies w1<0.1d (here, d is the total reflection interval of the light in the light guide plate).

Next, the shape of the TZc will be described.

In order to improve MTF degradation, the MTF degradation is only required not to be completely cancelled but to be weakened. Therefore, the TZc needs not have a shape completely matching that of the TZ, that is, there is a tolerance related to the shape of the TZc and a tolerance related to the position. These tolerances will be described below.

The widths of the slope in the shape of the TZc are defined as wc1 and wc2, and the angles formed by the slope of the TZc and the substrate are defined as φc1 and φc2.

In this case, the shape of the TZc is expressed by the following four mathematical expressions.

$$wc 1 < 0.1 * d ,$$

$$wc 2 = w 2 + Δ w ,$$

$$φ c 2 = φ 2 + Δφ , and$$

$$x = d / 2 + n * d + Δ x$$

Here, parameters in these mathematical expressions are as follows.
x: horizontal distance difference between vertex of TZ and end of TZc
Δw: tolerance of slope width of TZc
Δφ: tolerance of slope angle of TZc
Δx: tolerance of x
n: any integer

For x, d/2+n*d represents an interval at which the light beam shining on the TZ present on the front surface of the light guide plate shines on the back surface. x is the horizontal distance from the left end of the slope 2 of the first structure to the left end of the slope of the second structure having a role of canceling the influence of the slope 2. Δx is (half the total reflection interval of the light beam)+ (integer multiple of the total reflection interval of the light beam), that is, an error from (d/2+n*d). Therefore, as described above, x is expressed as x=d/2+n*d+Δx.

The ranges of Δw, Δφ, Δx, and n in the mathematical expressions described above will be further described below.

In a case where the TZc is arranged at a position where the angle deviation of the light beam by the TZ is corrected, the width and the position of the slope of the TZc affect the light beam ratio at which the angle deviation can be corrected, and the angle of the slope affects how much the angle of the deviation of the light beam can be returned. These parameters can be expressed by the shape of the PSF similarly to the configuration example 1 of the slope (in particular, configuration examples 1-1 to 1-3), that is, the MTF value can be derived. Since w2≥d, the idea of the PSF is as illustrated on FIG. 9B.

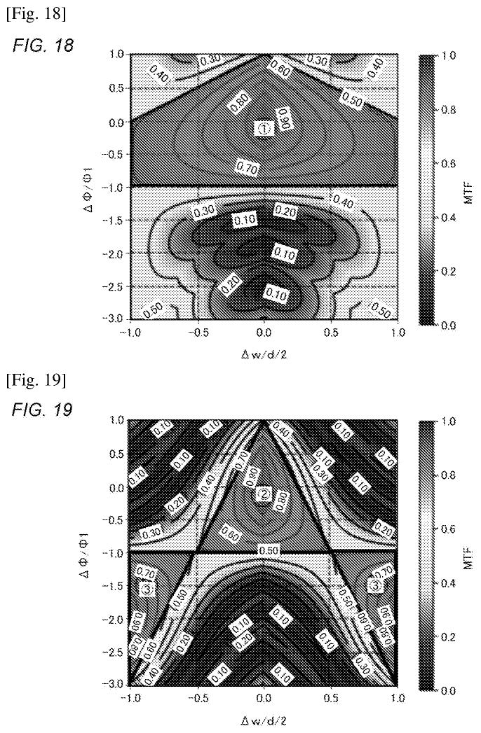

FIG. 18 illustrates the MTF distribution when Δw (horizontal axis) and Δφ (vertical axis) change.

From the figure, the range in which the MTF value becomes higher than the MTF value in a case where the TZc is absent, that is, the range indicated by the circled number 1 is expressed by the relational expression illustrated in (Mathematical Expression 9-1) below.

Furthermore, FIG. 19 illustrates the MTF distribution when Δx (horizontal axis) and Δφ (vertical axis) change. From the figure, the range in which the MTF value becomes higher than the MTF value in a case where the TZc is absent, that is, the range indicated by the circled number 2 and the range indicated by the circled number 3 are expressed by the relational expressions of (Mathematical Expression 9-2) and (Mathematical Expression 9-3), respectively, below.

In these mathematical expressions, in a case where φc2<0, it means a structure in which the right and left of the slope are reversed and the angle of the slope is −φc2.

$$\begin{matrix}[ Math . 20 ] & \\ \begin{matrix}- 1 \leq \frac{Δφ}{{φ}_{2}} \leq 1 - \vert \frac{Δ w}{d / 2} - 2 n \vert \\ \& \vert \frac{Δ w}{d / 2} - 2 n \vert \leq 1 \\ \& - {w}_{2} < Δ w\end{matrix} \} & ( Mathematical Expression 9 - 1 )\end{matrix}$$

$$or$$

$$\begin{matrix}- 1 \leq \frac{Δφ}{{φ}_{2}} \leq 1 - 4 \vert \frac{Δ x}{d / 2} - 2 n \vert \\ \& \vert \frac{Δ w}{d / 2} - 2 n \vert \leq \frac{1}{2}\end{matrix} \} \qquad ( Mathematical Expression 9 - 2 )$$

$$or$$

$$\begin{matrix}1 - 4 \vert \frac{Δ x}{d / 2} - 2 n \vert \leq \frac{Δφ}{{φ}_{2}} \leq - 1 \\ \& \frac{1}{2} \leq \vert \frac{Δ x}{d / 2} - 2 n \vert \leq 1\end{matrix} \} \qquad ( Mathematical Expression 9 - 3 )$$

where, in Mathematical Expressions 9-1, 9-2, and 9-3,
Δφ is a tolerance of slope angle of mountain shape of the second structure,
φ₂ is an angle formed by a slope 2 on the second diffraction grating side of the first structure and the first surface of the light guide plate,
Δw is a tolerance of slope width of mountain shape of the second structure,
d is a total reflection interval of the light as described above,
n is an any integer,
Δx is an error of x, and x is ((half total reflection interval of light beam)+ (integer multiple of total reflection interval of light beam)),
w₂ is width w2 of slope 2 on the second diffraction grating side of the first structure. Thus, when any condition of (Mathematical Expression 9-1), (Mathematical Expression 9-2), and (Mathematical Expression 9-3) is satisfied, MTF degradation in a case where the spatial frequency is 10 cycle/deg can be improved.

### 1.7.2 Example 2 of TZc Existing on Surface on Opposite Side to Surface where TZ Exists

In 1.7.1 described above, the case where the width of slope 2 is w2≥d has been described regarding the shape of the TZ.

Hereinafter, a case where the width of the slope 2 is w2<d will be described.

The widths of the slope in the shape of the TZc are defined as wc1 and wc2, and the angles formed by the slope of the TZc and the substrate are defined as φc1 and φc2.

In this case, the shape of the TZc is expressed by the following four mathematical expressions. Wc1<0.1*d, wc2=w2+Aw, qc2=q2+Δφ, and x=d/2+n*d+Δx are satisfied.

Here, for x, d/2+n*d represents an interval at which the light beam shining on the TZ present on the front surface of the light guide plate shines on the back surface.

The ranges of Δw, Δφ, Δx, and n in the mathematical expressions described above will be described below. Since w2<d, the idea of the PSF is as illustrated on FIG. 9A.

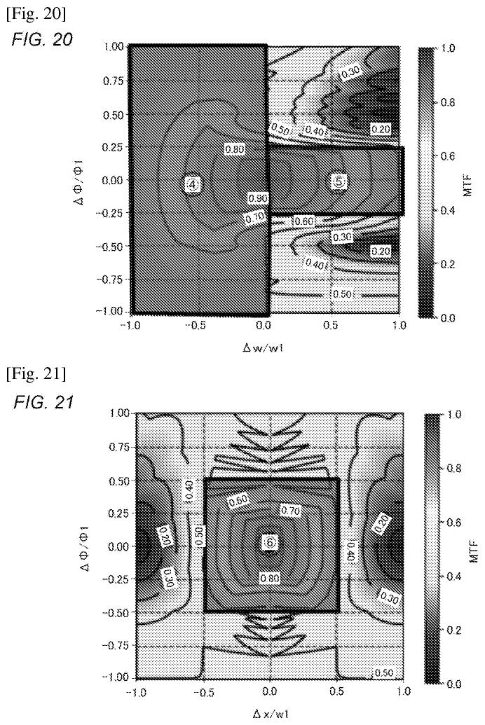

FIG. 20 illustrates the MTF distribution when Δw (horizontal axis) and Δφ (vertical axis) change. From this figure, the range that becomes higher than the MTF value when the TZc is absent, that is, the range indicated by the circled number 4 and the range indicated by the circled number 5 are expressed by the relational expressions of (Mathematical Expression 10-1) and (Mathematical Expression 10-2), respectively.

Furthermore, FIG. 21 illustrates the MTF distribution when Δx (horizontal axis) and Δφ (vertical axis) change. From this figure, the range in which the MTF value becomes higher than that of the MTF value when the TZc is absent, that is, the range indicated by the circled number 6 is expressed by the relational expression of (Mathematical Expression 10-3).

However, in a case where φc2<0, it means a structure in which the right and left of the slope are reversed and the angle of the slope is −φc2.

$$\begin{matrix}[ Math . 21 ] & \\ \vert \frac{Δφ}{{φ}_{2}} \vert \leq 1 \& - 1 \leq \frac{Δ w}{{w}_{2}} \leq 0 & ( Mathematical Expression 10 - 1 )\end{matrix}$$

$$or$$

$$\vert \frac{Δφ}{{φ}_{2}} \vert \leq \frac{1}{4} \& 0 \leq \frac{Δ w}{{w}_{2}} \leq 1 \qquad ( Mathematical Expression 10 - 2 )$$

$$or$$

$$\vert \frac{Δφ}{{φ}_{2}} \vert \leq \frac{1}{2} \& \vert \frac{Δ x}{{w}_{2}} \vert \leq \frac{1}{2} \qquad ( Mathematical Expression 10 - 3 )$$

where, in Mathematical Expressions 10-1, 10-2, and 10-3,
Δφ is a tolerance of slope angle of mountain shape of the second structure,
φ₂ is an angle formed by a slope 2 on the second diffraction grating side of the first structure and the first surface of the light guide plate,
Δw is a tolerance of slope width of mountain shape of the second structure,
Δx is an error of x, and x is ((half total reflection interval of light beam)+ (integer multiple of total reflection interval of light beam)),
w₂ is width w2 of slope 2 on the second diffraction grating side of the first structure. Thus, when any condition of (Mathematical Expression 10-1), (Mathematical Expression 10-2), and (Mathematical Expression 10-3) is satisfied, MTF degradation in a case where the spatial frequency is 10 cycle/deg can be improved.

### 1.7.3 Example 1 of TZc Existing on Surface where TZ Exists

In 1.7.1 described above, a configuration example in the case where the TZc exists on the surface on the opposite side to the surface where the TZ exists has been described.

Hereinafter, a case where the TZc exists on the same plane as the plane where the TZ exists will be described.

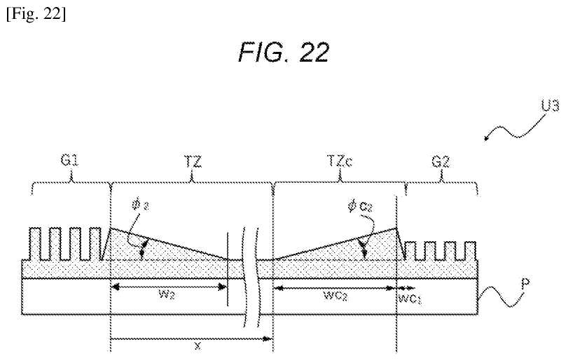

In this case, as illustrated in FIG. 22, the TZc may have substantially the same shape as that of the TZ. The TZc may be arranged to be line-symmetric with respect to an axis orthogonal to the substrate.

First, the shape of the TZ will be described.

Regarding the shape of the TZ, similarly to the 1.7.1 described above, preferably, the width w1 of the slope 1 satisfies w1<0.1*d, and the width w2 of the slope 2 satisfies w2≥d. Here, d is the total reflection interval of the light in the light guide plate. By satisfying w1<0.1*d, it becomes easy to form the TZc.

Furthermore, in this case, the influence of one slope (slope of w1) is so very small that there is also an advantage that it is only required to cancel only the influence of the other slope.

Next, the shape of the TZc will be described.

In order to improve MTF degradation, the MTF degradation is only required not to be completely cancelled but to be weakened. Therefore, the TZc needs not have a shape completely matching that of the TZ, that is, there is a tolerance related to the shape of the TZc and a tolerance related to the position. These tolerances will be described below.

The widths of the slope in the shape of the TZc are defined as wc1 and wc2, and the angles formed by the slope of the TZc and the substrate are defined as φc1 and φc2.

In this case, the shape of the TZc is expressed by the following four mathematical expressions.

$$wc 1 < 0.1 * d ,$$

$$wc 2 = w 2 + Δ w ,$$

$$φ c 2 = φ 2 + Δφ ,$$

$$x = d + n * d + Δ x .$$

Here, parameters in these mathematical expressions are as follows.
x: horizontal distance difference between vertex of TZ and end of TZc
Δw: tolerance of slope width of TZc
Δp: tolerance of slope angle of TZc
Δx: tolerance of x
n: any integer

For x, d+n*d represents an interval at which the light beam shining on the TZ present on the front surface of the light guide plate shines on the front surface again.

Regarding the above mathematical expressions, the ranges of Δw, Δφ, Δx, and n may be expressed by (Mathematical Expression 9-1), (Mathematical Expression 9-2), and (Mathematical Expression 9-3) described in 1.7.1 described above. That is, regarding Δw, Δφ, Δx, and n, when any condition of (Mathematical Expression 9-1), (Mathematical Expression 9-2), and (Mathematical Expression 9-3) is satisfied, MTF degradation in a case where the spatial frequency is 10 cycle/deg can be improved.

### 1.7.4 Example 2 of TZc Existing on Surface where TZ Exists

In 1.7.3 described above, the case where the width of slope 2 is w2≥d has been described regarding the shape of the TZ.

Hereinafter, a case where the width of the slope 2 is w2<d will be described.

In this case, as described in 1.7.2 described above, the widths of the slope in the shapes of the TZc are wc1 and wc2, and the angles formed by the slopes of the TZc and the substrate are φc1 and φc2.

In this case, the shape of the TZc is expressed by the following four mathematical expressions.

$$wc 1 < 0.1 * d ,$$

$$wc 2 = w 2 + Δ w ,$$

$$φ c 2 = φ 2 + Δφ ,$$

$$x = d + n * d + Δ x .$$

Here, for x, d+n*d represents an interval at which the light beam shining on the TZ present on the front surface of the light guide plate shines on the front surface again.

Regarding the above mathematical expressions, the ranges of Δw, Δφ, Δx, and n may be expressed by (Mathematical Expression 10-1), (Mathematical Expression 10-2), and (Mathematical Expression 10-3) described in 1.7.2 described above. That is, regarding Δw, Δφ, Δx, and n, when any condition of (Mathematical Expression 10-1), (Mathematical Expression 10-2), and (Mathematical Expression 10-3) is satisfied, MTF degradation in a case where the spatial frequency is 10 cycle/deg can be improved.

### 1.8 Coating Layer

In one embodiment, a zone where the structure exists may be provided with a reflective coating layer configured to prevent the light from entering the structure, or a coating layer configured to prevent the light having entered the structure from causing an angle deviation due to a slope of the mountain shape. Such a reflective coating layer or a coating layer can also suppress MTF degradation. Also the light guide plate unit having such a configuration can eliminate MTF degradation, can satisfy the condition of Mathematical Expression 1 described above, and further satisfy the condition of Mathematical Expression 5. These layers will be described in more detail below.

### 1.8.1 Example of Reflective Coating Layer

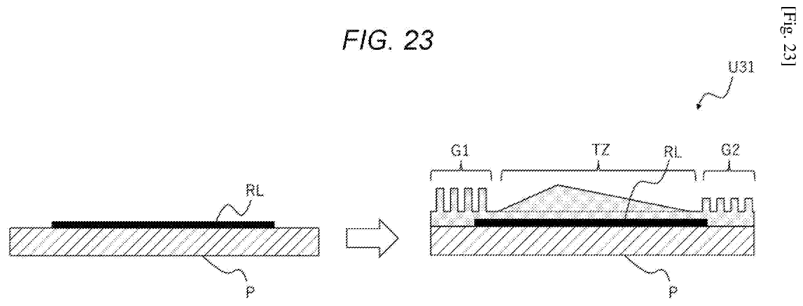

Hereinafter, a configuration example of the light guide plate unit of the present disclosure provided with the reflective coating layer will be described with reference to FIG. 23. The figure is a schematic diagram of the configuration example.

As illustrated on the left of the figure, a reflective coating layer RL is laminated on the light guide plate P to obtain a laminate. Then, by forming the diffraction grating by inkjet and nanoimprinting on the laminate, the diffraction gratings G1 and G2 and the mountain shape structure TZ are formed as illustrated on the right of the figure. This gives a light guide plate unit U31 including the light guide plate P, the reflective coating layer RL, the diffraction gratings G1 and G2, and the mountain shape structure TZ. Thus, the reflective coating layer may be provided between the light guide plate and the structure.

Here, the diffraction gratings G1 and G2 are not formed in the zone where the reflective coating layer RL exists, and are formed to be in contact with the light guide plate P.

On the other hand, the mountain shape structure TZ is formed on the reflective coating layer RL. That is, in the zone where a reflective coating layer CL exists, a laminate structure in which the light guide plate P, the reflective coating layer RL, and the mountain shape structure TZ are laminated in this order is formed.

The zone where the reflective coating layer RL exists may be formed to cover the entire zone where the mountain shape structure TZ exists, and the zone where the reflective coating layer RL exists may be wider than the zone where the mountain shape structure TZ exists.

As described above, a light guide plate unit U31 has the reflective coating layer RL between the mountain shape structure TZ and the light guide plate P. Due to the reflective coating layer CL, the light traveling in the light guide plate is totally reflected by the flat surface of the light guide plate P without shining on the TZ, and therefore there is no MTF degradation. Thus, the reflective coating layer can greatly alleviate MTF degradation due to the TZ.

Preferably, the reflective coating layer may include a metallic material, that is, may be a metal reflective coating layer. The metal material may contain, for example, aluminum, silver, gold, an aluminum alloy, copper, mercury, chromium, nickel, platinum, or tin as a main component, and preferably contains aluminum, silver, gold, or an aluminum alloy as a main component.

The film thickness of the reflective coating layer may be, for example, 10 nm or more, preferably 20 nm or more, and more preferably 30 nm or more. The film thickness may be, for example, 500 nm or less, 400 nm or less, 300 nm or less, or 200 nm or less.

The reflective coating layer is not necessarily formed by coating treatment, and may be formed by another method. For example, the reflective coating layer may be formed by vapor deposition or sputtering. The reflective coating layer may be called a reflective layer.

### 1.8.2 Example of Coating Layer

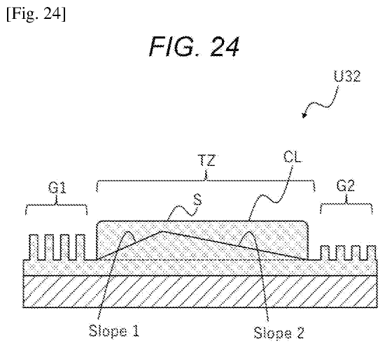

Hereinafter, the light guide plate unit of the present disclosure including a coating layer configured so that the light entering the structure does not cause angle deviation by the slope of the mountain shape will be described with reference to FIG. 24. The figure is a schematic diagram of the light guide plate unit.

As in a light guide plate unit U32 illustrated in the figure, by forming the diffraction grating by inkjet and nanoimprinting on the laminate, the diffraction gratings G1 and G2 and the mountain shape structure TZ are formed on the light guide plate P. Then, moreover, the coating layer CL is formed to cover a zone where the mountain shape structure TZ exists. That is, in the zone where the mountain shape structure TZ exists, a laminate structure in which the light guide plate P, the mountain shape structure TZ, and the coating layer CL exist in this order is formed.

This gives a light guide plate unit U32 including the light guide plate P, the diffraction gratings G1 and G2, the mountain shape structure TZ, and the coating layer CL.

As illustrated in the figure, the coating layer CL may be provided to cover the mountain shape TZ and form a flat shape (flat surface S). The coating layer may include a material having substantially the same refractive index as that of the material of the TZ, and preferably, may include a material having the same refractive index as that of the TZ.

Due to such a coating layer, the TZ approaches flat, so that the influence on light beams becomes small, and MTF degradation is alleviated.

Furthermore, in the present disclosure, the structure including the original TZ and the coating layer may be regarded as one new TZ. Then, any of the means described above in 1.8.1 or earlier may be applied to the new TZ.

### 1.9 Example of Case of Having Structure Having Plurality of Mountain Shapes

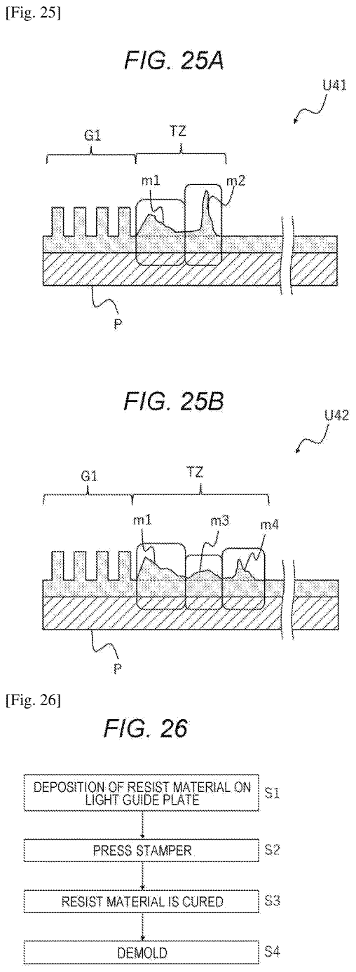

A light guide plate unit of the present disclosure may include a structure having a plurality of mountain shapes provided between the first diffraction grating and the second diffraction grating. In this case, preferably, heights of all of the plurality of mountain shapes are equal to or less than 90 nm. Therefore, MTF degradation can be suppressed. Also the light guide plate unit having such a configuration can eliminate MTF degradation, can satisfy the condition of Mathematical Expression 1 described above, and further satisfy the condition of Mathematical Expression 5. This will be described below with reference to FIGS. 25A and 25B.

As a light guide plate unit U41 illustrated in FIG. 25A, there is a case where two structures m1 and m2 having mountain shapes are formed in the formation process of the diffraction grating. For example, in a case where a resist material having a high refractive index is used for forming the diffraction grating and a distance between the two diffraction gratings is large, there is a case where the mountain shape structure m2 having a high height is formed next to the mountain shape structure m1 closest to the diffraction grating G1. In such the light guide plate unit U41, in a case where the height of the structure m2 is too high, for example, in a case where the height exceeds 90 nm, in particular, the possibility of causing MTF degradation increases.

Therefore, in the light guide plate unit of the present disclosure, in a case where a plurality of mountain shapes is provided between two diffraction gratings, it is desirable that the height of any of these mountain shapes is preferably 90 nm or less, more preferably 85 nm or less, and still more preferably 80 nm or less.

That is, as in a light guide plate unit U42 illustrated in FIG. 25B, mountain shape structures m3 and m4 may be formed next to the mountain shape structure m1 instead of the structure m1, and the height of any of these structures m1, m3, and m4 is preferably 90 nm or less, more preferably 85 nm or less, and still more preferably 80 nm or less.

Therefore, it is possible to prevent MTF degradation. Therefore, the degradation rate of the MTF at the spatial frequency of 10 cycle/deg can be made 50% or less.

### 1.10 Manufacturing Method

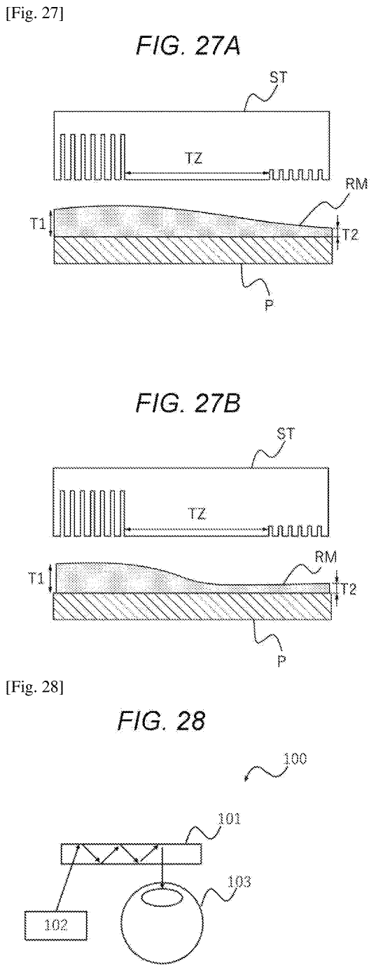

The light guide plate unit according to the present disclosure can be manufactured by a manufacturing method using a nanoimprint technology, for example. In particular, the manufacturing method may include depositing a resist material on the light guide plate by the inkjet method, and the deposition of the resist material using the inkjet method leads to formation of the structure of the mountain shape on the light guide plate. The manufacturing method will be described below with reference to the flowchart illustrated in FIG. 26 and the schematic diagrams of FIGS. 27A and 27B.

In step S1 illustrated in the figure, a resist material RM is deposited on the light guide plate P. The resist material may be, for example, any photocurable resin composition, and may be particularly an ultraviolet curable resin composition. The resist material may contain, as a resin component, for example, any one or a combination of two or more of an acrylic resin, a polyimide resin, a melamine resin, a polyester resin, a polycarbonate resin, a phenol resin, and an epoxy resin. Furthermore, these photocurable resins may contain nanoparticles. Any generally known nanoparticle can be used as the nanoparticles, and examples thereof include titanium oxide, zirconia oxide, silica, silicon, and nanodiamond. Furthermore, in a case where nanoparticles are contained, one type or two or more types of nanoparticles may be contained in the photocurable resin. The light guide plate P may include any material that can be used as a light guide plate material in the technical field, and the material of the light guide plate P may be, for example, an inorganic material, an organic material, or a hybrid material of these. Specific examples of the inorganic material include glass and silicon, and specific examples of the organic material include a polycarbonate-based resin, an acrylic resin, a thiourethane-based resin, and an epoxy-based resin.

In step S1, the resist material is applied onto the light guide plate by the inkjet method, for example. In the application by the inkjet method, the structure of the mountain shape described above is easily formed, and the problem regarding the TZ described above is easily occur. The shape of the mountain shape structure included in the light guide plate unit can be adjusted by adjusting the dropping amount and the position of the resist material in step S1. More specifically, by adjusting the resist material dropping amount in the zone where the TZ occurs, the resist material dropping amount in the surrounding zone where two diffraction gratings are formed, and the position where these resist materials are dropped, the shape of the mountain shape structure can be adjusted to a desired shape (for example, to a shape in which MTF degradation is suppressed).

For example, in a case where the light guide plate unit obtained in a case where the resist material is dropped as illustrated in FIG. 27A does not have the characteristics regarding the MTF according to the present disclosure, for example, the slope and the height can be adjusted by adjusting the dropping amount and the position of the resist material as illustrated in FIG. 27B, and the light guide plate unit having the characteristics regarding the MTF according to the present disclosure can be obtained. The dropping amount and the position of these resist materials can be appropriately adjusted by those skilled in the art according to, for example, desired performance of the light guide plate unit and the type or characteristics of the resist material.

Note that, the thicknesses T1 and T2 of the resist material necessary for forming the first diffraction grating and the second diffraction grating are determined according to the structures of these diffraction gratings. Therefore, it is possible to form the TZ having each diffraction grating and a desired shape by adjusting the thickness distribution of the resist material in the TZ while satisfying these thicknesses in the zone where each diffraction grating is formed.

In step S2, the stamper ST is pressed against the light guide plate. That is, the stamper and the light guide plate are pressed in such a manner that these sandwich the resist material. Therefore, it enters the pattern for forming a diffractive configuration provided in advance in the stamper.

In step S3, the resist material is cured. The curing may also be called transfer. The means for curing may be appropriately selected according to, for example, the type of resin. In a case where the resin is photocurable, the resin may be irradiated with light. More specifically, in a case where the resin is an ultraviolet curable resin, the resin is irradiated with ultraviolet rays. By the curing, the first diffraction grating and the second diffraction grating are formed, and the mountain shape structure existing between them is also formed.

In step S4, the stamper is separated from the light guide plate. That is, the diffraction grating is demolded from the stamper mold. In this way, the light guide plate unit according to the present disclosure is manufactured.

### 1.11 Use Method

The light guide plate unit according to the present disclosure may be used for manufacturing an image display device. Then, the light guide plate unit may be used for guiding light (in particular, image display light) emitted from the drawing engine to the eyes of the user, in the image display device, for example. Since the light guide plate unit can prevent degradation of the MTF, an image with better image quality can be presented to the user. A configuration example of the image display light will be described below.

### 2. Second Embodiment (Image Display Device)

The present disclosure also provides an image display device including the light guide plate unit described in 1 described above. An example of the image display device will be described with reference to FIG. 28.

An image display device 100 illustrated in the figure includes a light guide plate unit 101 and a drawing system 102.

The light guide plate unit 101 may be any of the light guide plate units of the present disclosure described in 1 described above.

The drawing system 102 forms image display light guided by the light guide plate unit 101. The light guide plate unit 101 guides the image display light to reach an eye 103 of the user.

Although not illustrated in the figure, the image display device 100 may have one or more optical elements on an optical path between the drawing system 102 and the light guide plate unit 101. The optical element may include a light guide optical system, and the light guide optical system may include, for example, one or more collimator lenses and/or one or more relay lenses.

The drawing system 102 may be stored in a housing. The housing may also store the light guide optical system.

Furthermore, the image display device 100 may further include an instrument for holding the light guide plate unit 101 in front of the eyes. The instrument may include a temple part and a rim part of eyeglasses, for example. The instrument may be a band for fixing the image display device 100 to the head. The instrument may be attached with the housing.

The image display device 100 may be configured as, for example, a head mounted display (hereinafter also called HMD). The head mounted display may be, for example, a transmissive HMD or a non-transmissive HMD.

The transmissive HMD may be configured as, for example, an eyeglass-type display. In this case, the light guide plate unit 101 can transmit light from an external view to reach the eye. The light guide plate unit 101 may be provided in a part corresponding to the lens of the eyeglass. A video presented by the image display device 100 can be superimposed on the external view by the transmissive HMD, and for example, AR can be provided to the user.

The non-transmissive HMD may completely cover both eyes, for example. In this case, light from the external view does not reach the eyes.

The present disclosure can also adopt the following configurations.

<1>

A light guide plate unit including:
a light guide plate; and
a structure having a first diffraction grating provided on one surface of the light guide plate, a second diffraction grating that diffracts light diffracted by the first diffraction grating, and a mountain shape existing between the first diffraction grating and the second diffraction grating, in which
the light guide plate unit is configured to satisfy a following Mathematical Expression 1 when an MTF value of light immediately before entering the mountain shape in a case where a spatial frequency is 10 cycle/deg is X₁₀ and an MTF value of light immediately after passing through the mountain shape is Y₁₀.

$$[ Math . 22 ]$$

$$0 ≦ ( 1 - {Y}_{10} / {X}_{10} ) ≦ 0.5 \qquad ( Mathematical Expression 1 )$$

<2>

The light guide plate unit according to <1>, in which
in a case where a width of a slope of the mountain shape is less than a total reflection interval of the light in the light guide plate, the slope is configured in such a manner that a width of the slope is equal to or less than a threshold specified on the basis of the total reflection interval, and
in a case where a width of a slope of the mountain shape is equal to or greater than a total reflection interval of the light in the light guide plate, the slope is configured in such a manner that a height of the slope is equal to or less than a threshold specified on the basis of the width of the slope and an inclination angle of the slope.
   <3>

The light guide plate unit according to <1> or <2>, in which
in a case where each of a width w1 of a slope 1 on the first diffraction grating side of the mountain shape and a width w2 of a slope 2 on the second diffraction grating side is equal to or greater than a total reflection interval d of the light in the light guide plate,
the mountain shape is configured in in such a manner that a height h1 of the slope 1 and a height h2 of the slope 2 satisfy the following Mathematical Expression 2,

$$[ Math . 23 ]$$

$$\begin{matrix}0 < h 1 ≦ w 1 * tan ( 0.025 [ deg ] * A ) \\ and \\ 0 < h 2 ≦ w 2 * tan ( 0.025 [ deg ] * A )\end{matrix} \} \qquad ( Mathematical Expression 2 )$$

where, in Mathematical Expression 2,
h1=(height from reference surface of the first diffraction grating to vertex of the mountain shape)
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape),
in a case where the width w1 of the slope 1 on the first diffraction grating side of the mountain shape is less than the total reflection interval d of the light in the light guide plate, and the width w2 of the slope 2 on the second diffraction grating side is equal to or greater than the total reflection interval d of the light in the light guide plate, the mountain shape is configured in such a manner that the width w1 of the slope 1 and the height h2 of the slope 2 satisfy the following Mathematical Expression 3,

$$[ Math . 24 ]$$

$$\begin{matrix}0 < w 1 ≦ 0.23 * d \\ and \\ 0 < h 2 ≦ w 2 * tan ( 0.025 [ deg ] * A )\end{matrix} \} \qquad ( Mathematical Expression 3 )$$

where, in Mathematical Expression 3,
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape), and,
in a case where each of the width w1 of the slope 1 on the first diffraction grating side and the width w2 of the slope 2 on the second diffraction grating side of the mountain shape is less than the total reflection interval d of the light in the light guide plate, the mountain shape may be configured in such a manner that the width w1 of the slope 1 and the width w2 of the slope 2 satisfy the following Mathematical Expression 4

$$[ Math . 25 ]$$

$$\begin{matrix}0 < w 1 ≦ 0.15 * d \\ and \\ 0 < w 2 ≦ 0.15 * d\end{matrix} \} \qquad ( Mathematical Expression 4 )$$

where, in Mathematical Expression 4,
w1=(width of slope 1)
w2=(width of slope 2).
   <4>

The light guide plate unit according to any one of <1> to <3>, in which
the light guide plate unit is configured to satisfy the following Mathematical Expression 5 when an MTF value of light immediately before entering the mountain shape in a case where a spatial frequency is 20 cycle/deg is X₂₀ and an MTF value of light immediately after passing through the mountain shape is Y₂₀.

$$[ Math . 26 ]$$

$$0 ≦ ( 1 - {Y}_{20} / {X}_{20} ) ≦ 0.5 \qquad ( Mathematical Expression 5 )$$

<5>

The light guide plate unit according to <4>, in which
in a case where each of a width w1 of a slope 1 on the first diffraction grating side and a width w2 of a slope 2 on the second diffraction grating side of the mountain shape is equal to or greater than a total reflection interval d of the light in the light guide plate, the mountain shape is configured in such a manner that a height h1 of the slope 1 and a height h2 of the slope 2 satisfy the following Mathematical Expression 6,

$$[ Math . 27 ]$$

$$\begin{matrix}0 < h 1 ≦ w 1 * tan ( 0.0125 [ deg ] * A ) \\ and \\ 0 < h 2 ≦ w 2 * tan ( 0.0125 [ deg ] * A )\end{matrix} \} \qquad ( Mathematical Expression 6 )$$

where, in Mathematical Expression 6,
h1=(height from reference surface of the first diffraction grating to vertex of the mountain shape)
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape),
in a case where the width w1 of the slope 1 on the first diffraction grating side is less than the total reflection interval d of the light in the light guide plate, and the width w2 of the slope 2 on the second diffraction grating side of the mountain shape is equal to or greater than the total reflection interval d of the light in the light guide plate, the mountain shape is configured in such a manner that the width w1 of the slope 1 and the height h2 of the slope 2 satisfy the following Mathematical Expression 7,

$$[ Math . 28 ]$$

$$\begin{matrix}0 < w 1 ≦ 0.2 * d \\ and \\ 0 < h 2 ≦ w 2 * tan ( 0.0125 [ deg ] * A )\end{matrix} \} \qquad ( Mathematical Expression 7 )$$

where, in Mathematical Expression 7,
w1=(width of slope 1)
h2=(height from reference surface of the second diffraction grating to vertex of the mountain shape)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the mountain shape)
θ′_{TIR}=(light guide angle in structure of the mountain shape),
and,
in a case where each of the width w1 of the slope 1 on the first diffraction grating side and the width w2 of the slope 2 on the second diffraction grating side of the mountain shape is less than the total reflection interval d of the light in the light guide plate, the mountain shape may be configured in such a manner that the width w1 of the slope 1 and the width w2 of the slope 2 satisfy the following Mathematical Expression 8,

$$[ Math . 29 ]$$

$$\begin{matrix}0 < w 1 ≦ 0.15 * d \\ and \\ 0 < w 2 ≦ 0.15 * d\end{matrix} \} \qquad ( Mathematical Expression 8 )$$

where, in Mathematical Expression 8,
w1=(width of slope 1)
w2=(width of slope 2).
   <6>

The light guide plate unit according to any one of <1> to <5>, in which
the light guide plate unit further includes, on the one surface or the other surface of the light guide plate, a second structure having a mountain shape configured to cancel an angle deviation of the light caused by the structure (hereinafter called “first structure”).
   <7>

The light guide plate unit according to <6>, in which
the width w1 of the slope 1 on the first diffraction grating side of the first structure is configured to satisfy
w1<0.1d
(here, d is a total reflection interval of the light in the light guide plate).
   <8>

The light guide plate unit according to <7>, in which
in a case where the width w2 of the slope 2 on the second diffraction grating side of the first structure is equal to or greater than the total reflection interval d of the light, the mountain shape of the second structure is configured to satisfy any of the following Mathematical Expressions 9-1, 9-2, and 9-3,

$$[ Math . 30 ]$$

$$\begin{matrix}- 1 \leq \frac{Δφ}{{φ}_{2}} \leq 1 - \vert \frac{Δ w}{d / 2} - 2 n \vert \\ \& \vert \frac{Δ w}{d / 2} - 2 n \vert \leq 1 \\ \& - {w}_{2} < Δ w\end{matrix} \} or \qquad ( Mathematical Expression 9 - 1 )$$

$$\begin{matrix}- 1 \leq \frac{Δφ}{{φ}_{2}} \leq 1 - 4 \vert \frac{Δ x}{d / 2} - 2 n \vert \\ \& \vert \frac{Δ x}{d / 2} - 2 n \vert \leq \frac{1}{2}\end{matrix} \} or \qquad ( Mathematical Expression 9 - 2 )$$

$$\begin{matrix}1 - 4 \vert \frac{Δ x}{d / 2} - 2 n \vert \leq \frac{Δφ}{{φ}_{2}} \leq - 1 \\ \& \frac{1}{2} \leq \vert \frac{Δ x}{d / 2} - 2 n \vert \leq 1\end{matrix} \} \qquad ( Mathematical Expression 9 - 3 )$$

where, in Mathematical Expressions 9-1, 9-2, and 9-3,
Δφ is a tolerance of slope angle of mountain shape of the second structure, φ₂ is an angle formed by a slope 2 on the second diffraction grating side of the first structure and the first surface of the light guide plate,
Δw is a tolerance of slope width of mountain shape of the second structure,
d is a total reflection interval of the light as described above,
n is an any integer,
Δx is an error of x, and x is ((half total reflection interval of light beam)+ (integer multiple of total reflection interval of light beam)),
w₂ is width w2 of slope 2 on the second diffraction grating side of the first structure, and
in a case where the width w2 of the slope 2 on the second diffraction grating side of the first structure is less than the total reflection interval d of the light, the mountain shape of the second structure is configured to satisfy any of the following Mathematical Expressions 10-1, 10-2, and 10-3,

$$[ Math . 31 ]$$

$$\begin{matrix}\vert \frac{Δφ}{{φ}_{2}} \vert \leq 1 & \& & - 1 \leq \frac{Δ w}{{w}_{2}} \leq 0\end{matrix} or \qquad ( Mathematical Expression 10 - 1 )$$

$$\begin{matrix}\vert \frac{Δφ}{{φ}_{2}} \vert \leq \frac{1}{4} & \& & 0 \leq \frac{Δ w}{{w}_{2}} \leq 1\end{matrix} or \qquad ( Mathematical Expression 10 - 2 )$$

$$\begin{matrix}\vert \frac{Δφ}{{φ}_{2}} \vert \leq \frac{1}{2} & \& & \vert \frac{Δ x}{{w}_{2}} \vert \leq \frac{1}{2}\end{matrix} \qquad ( Mathematical Expression 10 - 3 )$$

where, in Mathematical Expressions 10-1, 10-2, and 10-3,
Δφ is a tolerance of slope angle of mountain shape of the second structure,
φ₂ is an angle formed by a slope 2 on the second diffraction grating side of the first structure and the first surface of the light guide plate,
Δw is a tolerance of slope width of mountain shape of the second structure,
Δx is an error of x, and x is ((half total reflection interval of light beam)+ (integer multiple of total reflection interval of light beam)),
w₂ is width w2 of slope 2 on the second diffraction grating side of the first structure.
   <9>

The light guide plate unit according to any one of <1> to <8>, in which
a zone where the structure exists is provided with
a reflective coating layer configured to prevent the light from entering the structure, or
a coating layer configured to prevent the light having entered the structure from causing an angle deviation due to a slope of the mountain shape.
   <10>

The light guide plate unit according to <9>, in which the reflective coating layer is provided between the light guide plate and the structure.

<11>

The light guide plate unit according to <9>, in which the coating layer includes a material having a refractive index substantially same as a refractive index of the structure.

<12>
The light guide plate unit according to <1> including a structure having a plurality of mountain shapes provided between the first diffraction grating and the second diffraction grating, in which
heights of all of the plurality of mountain shapes are equal to or less than 90 nm.
   <13>

The light guide plate unit according to any one of <1> to <12>, in which
the first diffraction grating is any diffraction grating of an incident diffraction grating configured to diffract light entering the light guide plate and cause the light to travel in the light guide plate, an expander configured to expand the light having traveled in the light guide plate, and an emission diffraction grating configured to emit the light from the light guide plate, and
the second diffraction grating is a recycler that diffracts light passing through the first diffraction grating and traveling toward an end of the light guide plate and causes the light to travel to the first diffraction grating again.
   <14>

The light guide plate unit according to any one of <1> to <12>, in which
the first diffraction grating is an incident diffraction grating configured to diffract light entering the light guide plate and cause the light to travel in the light guide plate, and the second diffraction grating is an expander configured to expand the light diffracted by the first diffraction grating and having traveled in the light guide plate.
   <15>

The light guide plate unit according to any one of <1> to <12>, in which
the first diffraction grating is an expander configured to expand light having traveled in the light guide plate, and
the second diffraction grating is an emission diffraction grating configured to emit, from the light guide plate, light expanded by the expander.
   <16>

The light guide plate unit according to any one of <1> to <12>, in which
the first diffraction grating is an incident diffraction grating configured to diffract light entering the light guide plate and cause the light to travel in the light guide plate, and
the second diffraction grating is an emission diffraction grating configured to emit, from the light guide plate, light having traveled in the light guide plate.
   <17>

The light guide plate unit according to <16>, in which the emission diffraction grating is an emission diffraction grating configured to expand light traveled in the light guide plate and emit the light from the light guide plate.

<18>

The light guide plate unit according to any one of <1> to <17>, in which the mountain shape structure includes a material used for forming the first diffraction grating, the second diffraction grating, or both of these diffraction gratings.

<19>

The light guide plate unit according to any one of <1> to <18>, in which the light guide plate unit is used for manufacturing an image display device.

<20>

An image display device including:
a light guide plate unit including
a light guide plate, and
a structure having a first diffraction grating provided on one surface of the light guide plate, a second diffraction grating that diffracts light diffracted by the first diffraction grating, and a mountain shape existing between the first diffraction grating and the second diffraction grating, in which
the light guide plate unit is configured to satisfy the following Mathematical Expression 1 when an MTF value of light immediately before entering the mountain shape in a case where a spatial frequency is 10 cycle/deg is X₁₀ and an MTF value of light immediately after passing through the mountain shape is Y₁₀.

$$\begin{matrix}[ Math . 32 ] & \\ 0 ≦ ( 1 - {Y}_{10} / {X}_{10} ) ≦ 0.5 & ( Mathematical Expression 1 )\end{matrix}$$

<21>

A light guide plate unit, comprising:
a light guide plate;
a first diffraction grating on a first surface side of the light guide plate;
a second diffraction grating on the first surface side of the light guide plate; and
a transition zone structure on the first surface side of the light guide plate, wherein the transition zone structure extends from a first end point at or adjacent to the first diffraction grating to a vertex point, and from the vertex point to a second end point at or between the first end point and the second diffraction grating, and wherein the first and second end points are closer to the first surface of the light guide plate than the vertex point.
   <22>

The light guide plate unit according to <21>, wherein
where a width of a first portion of the transition zone structure extending from the first end point to the vertex point is less than a total reflection interval of the light in the light guide plate, the width of the first portion of the transition zone structure is equal to or less than a threshold specified on a basis of the total reflection interval.
   <23>

The light guide plate unit according to <21>, wherein
where a width of a first portion of the transition zone structure extending from the first end point to the vertex point is equal to or greater than the total reflection interval of the light in the light guide plate, a height of the first portion of the transition zone structure is equal to or less than a threshold specified on a basis of the width of the first portion of the transition zone structure and an inclination angle of the first portion of the transition zone structure.
   <24>

The light guide plate unit according to any one of <21> to <23>, wherein
the light guide plate unit is configured to satisfy a following Mathematical Expression 1 when an MTF value of light immediately before entering the transition zone structure in a case where a spatial frequency is 10 cycle/deg is X₁₀ and an MTF value of light immediately after passing through the transition zone structure is Y₁₀

$$\begin{matrix}[ Math . 1 ] & \\ 0 ≦ ( 1 - {Y}_{10} / {X}_{10} ) ≦ 0.5 . & ( Mathematical Expression 1 )\end{matrix}$$

<25>

The light guide plate unit according to any one of <21> to <24>, wherein
where each of a width w1 of a slope 1 on a first diffraction grating side of the transition zone structure and a width w2 of a slope 2 on a second diffraction grating side of the transition zone structure is equal to or greater than a total reflection interval d of the light in the light guide plate,
the transition zone structure has a height h1 of the slope 1 and a height h2 of the slope 2 satisfy a following Mathematical Expression 2,

$$\begin{matrix}[ Math . 2 ] & \\ \begin{matrix}0 < h 1 ≦ w 1 * tan ( 0.025 [ deg ] * A ) \\ and \\ 0 < h 2 ≦ w 2 * tan ( 0.025 [ deg ] * A )\end{matrix} \} & ( Mathematical Expression 2 )\end{matrix}$$

where, in Mathematical Expression 2,
h1=(height from reference surface of the first diffraction grating to the vertex point of the transition zone structure)
w1=(width of slope 1)
h2=(height from reference surface of the second diffraction grating to vertex of the transition zone structure)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material of the transition zone structure)
θ′_{TIR}=(light guide angle in structure of the transition zone structure),
where the width w1 of the slope 1 on the first diffraction grating side of the transition zone structure is less than the total reflection interval d of the light in the light guide plate, and the width w2 of the slope 2 on the second diffraction grating side of the transition zone structure is equal to or greater than the total reflection interval d of the light in the light guide plate,
the width w1 of the slope 1 and the height h2 of the slope 2 satisfy a following Mathematical Expression 3,

$$\begin{matrix}[ Math . 3 ] & \\ \begin{matrix}0 < w 1 ≦ 0.23 * d \\ and \\ 0 < h 2 ≦ w 2 * tan ( 0.025 [ deg ] * A )\end{matrix} \} & ( Mathematical Expression 3 )\end{matrix}$$

where, in Mathematical Expression 3,
w1=(width of slope 1)
h2=(height from reference surface of the second diffraction grating to vertex of the transition zone structure)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the transition zone structure)
θ′_{TIR}=(light guide angle in structure of the transition zone structure), and,
where each of the width w1 of the slope 1 on the first diffraction grating side and the width w2 of the slope 2 on the second diffraction grating side of the transition zone structure is less than the total reflection interval d of the light in the light guide plate, the width w1 of the slope 1 and the width w2 of the slope 2 satisfy a following Mathematical Expression 4,

$$\begin{matrix}[ Math . 4 ] & \\ \begin{matrix}0 < w 1 ≦ 0.15 * d \\ and \\ 0 < w 2 ≦ 0.15 * d\end{matrix} \} & ( Mathematical Expression 4 )\end{matrix}$$

where, in Mathematical Expression 4,
w1=(width of slope 1)
w2=(width of slope 2).
   <26>

The light guide plate unit according to any one of <21> to <26>, wherein
the light guide plate unit is configured to satisfy a following Mathematical Expression 5 when an MTF value of light immediately before entering the transition zone structure in a case where a spatial frequency is 20 cycle/deg is X₂₀ and an MTF value of light immediately after passing through the transition zone structure is Y₂₀

$$\begin{matrix}[ Math . 5 ] & \\ 0 ≦ ( 1 - {Y}_{20} / {X}_{20} ) ≦ 0.5 . & ( Mathematical Expression 5 )\end{matrix}$$

<27>

The light guide plate unit according to <26>, wherein
where each of a width w1 of a slope 1 on the first diffraction grating side and a width w2 of a slope 2 on the second diffraction grating side of the transition zone structure is equal to or greater than a total reflection interval d of the light in the light guide plate, the transition zone structure has a height h1 of the slope 1 and a height h2 of the slope 2 that satisfy a following Mathematical Expression 6,

$$\begin{matrix}[ Math . 6 ] & \\ \begin{matrix}0 < h 1 ≦ w 1 * tan ( 0.0125 [ deg ] * A ) \\ and \\ 0 < h 2 ≦ w 2 * tan ( 0.0125 [ deg ] * A )\end{matrix} \} & ( Mathematical Expression 6 )\end{matrix}$$

where, in Mathematical Expression 6,
h1=(height from reference surface of the first diffraction grating to vertex of the transition zone structure)
w1=(width of slope 1)
h2=(height from reference surface of the second diffraction grating to vertex of the transition zone structure)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material forming structure of the transition zone structure)
θ′_{TIR}=(light guide angle in structure of the transition zone structure), where the width w1 of the slope 1 on the first diffraction grating side of the transition zone structure is less than the total reflection interval d of the light in the light guide plate, and the width w2 of the slope 2 on the second diffraction grating side of the transition zone structure is equal to or greater than the total reflection interval d of the light in the light guide plate,
the width w1 of the slope 1 and the height h2 of the slope 2 of the transition zone structure satisfy a following Mathematical Expression 7,

$$\begin{matrix}[ Math . 7 ] & \\ \begin{matrix}0 < w 1 ≦ 0.2 * d \\ and \\ 0 < h 2 ≦ w 2 * tan ( 0.0125 [ deg ] * A )\end{matrix} \} & ( Mathematical Expression 7 )\end{matrix}$$

where, in Mathematical Expression 7,
w1=(width of slope 1)
h2=(height from reference surface of the second diffraction grating to vertex of the transition zone structure)
w2=(width of slope 2)

$$A = cos ( {θ}_{airin} ) / ( 2 * {n}_{2} * cos ( {θ}_{TIR}^{′} ) )$$

θₐᵢᵣᵢₙ=(incident angle of the light when entering the light guide plate)
n₂=(refractive index of material of the transition zone structure)
θ′_{TIR}=(light guide angle in structure of the transition zone structure), and,
where each of the width w1 of the slope 1 on the first diffraction grating side and the width w2 of the slope 2 on the second diffraction grating side of the transition zone structure is less than the total reflection interval d of the light in the light guide plate, the width w1 of the slope 1 and the width w2 of the slope 2 of the transition zone structure satisfy a following Mathematical Expression 8,

$$\begin{matrix}[ Math . 8 ] & \\ \begin{matrix}0 < w 1 ≦ 0.15 * d \\ and \\ 0 < w 2 ≦ 0.15 * d\end{matrix} \} & ( Mathematical Expression 8 )\end{matrix}$$

where, in Mathematical Expression 8,
w1=(width of slope 1)
w2=(width of slope 2).
   <28>

The light guide plate unit according to any one of <21> to <27>, wherein the transition zone structure is a first transition zone structure, wherein the light guide plate unit further including a second transition zone structure on the first surface or on another surface of the light guide plate, wherein the second transition zone structure extends from a third end point to a vertex point of the second transition zone structure, and from the vertex point of the second transition zone structure to a fourth end point, and wherein the third and fourth end points are closer to the first or the another surface of the light guide plate than the vertex.

<29>

The light guide plate unit according to <28>, wherein
the width w1 of the slope 1 on the first diffraction grating side of the first transition zone structure is configured to satisfy

w1<0.1d
(where d is a total reflection interval of the light in the light guide plate).
   <30>

The light guide plate unit according to <29>, wherein
in a case where the width w2 of the slope 2 on the second diffraction grating side of the first transition zone structure is equal to or greater than the total reflection interval d of the light, the second transition zone structure is configured to satisfy any of a following Mathematical Expressions 9-1, 9-2, and 9-3,

$$\begin{matrix}[ Math . 9 ] & \\ \begin{matrix}- 1 \leq \frac{Δφ}{{φ}_{2}} \leq 1 - \vert \frac{Δ w}{d / 2} - 2 n \vert \\ \& \vert \frac{Δ w}{d / 2} - 2 n \vert \leq 1 \\ \& - {w}_{2} < Δ w\end{matrix} \} & ( Mathematical Expression 9 - 1 )\end{matrix}$$

$$or$$

$$\begin{matrix}- 1 \leq \frac{Δφ}{{φ}_{2}} \leq 1 - 4 \vert \frac{Δ x}{d / 2} - 2 n \vert \\ \& \vert \frac{Δ x}{d / 2} - 2 n \vert \leq \frac{1}{2}\end{matrix} \} \qquad ( Mathematical Expression 9 - 2 )$$

$$or$$

$$\begin{matrix}1 - 4 \leq \vert \frac{Δ x}{d / 2} - 2 n \vert \frac{Δφ}{{φ}_{2}} \leq - 1 \\ \& \frac{1}{2} \leq \vert \frac{Δ x}{d / 2} - 2 n \vert \leq 1\end{matrix} \} \qquad ( Mathematical Expression 9 - 3 )$$

where, in Mathematical Expressions 9-1, 9-2, and 9-3,
Δφ is a tolerance of slope angle of the second transition zone structure,
φ₂ is an angle formed by a slope 2 on the second diffraction grating side of the first transition zone structure and the first surface of the light guide plate,
Δw is a tolerance of slope width of the second transition zone structure,
d is a total reflection interval of the light as described above,
n is an any integer,
Δx is an error of x, and x is ((half total reflection interval of light beam)+ (integer multiple of total reflection interval of light beam)),
w₂ is width w2 of slope 2 on the second diffraction grating side of the first transition zone structure,
and
where the width w2 of the slope 2 on the second diffraction grating side of the first transition zone structure is less than the total reflection interval d of the light, the second transition zone structure is configured to satisfy any of a following Mathematical Expressions 10-1, 10-2, and 10-3,

$$\begin{matrix}[ Math . 10 ] & \\ \vert \frac{Δφ}{{φ}_{2}} \vert \leq 1 \& - 1 \leq \frac{Δ w}{{w}_{2}} \leq 0 & ( Mathematical Expression 10 - 1 )\end{matrix}$$

$$or$$

$$\vert \frac{Δφ}{{φ}_{2}} \vert \leq \frac{1}{4} \& 0 \leq \frac{Δ w}{{w}_{2}} \leq 1 \qquad ( Mathematical Expression 10 - 2 )$$

$$or$$

$$\vert \frac{Δφ}{{φ}_{2}} \vert \leq \frac{1}{2} \& \vert \frac{Δ w}{{w}_{2}} \vert \leq \frac{1}{2} \qquad ( Mathematical Expression 10 - 3 )$$

where, in Mathematical Expressions 10-1, 10-2, and 10-3,
Δφ is a tolerance of slope angle of the second transition zone structure,
φ₂ is an angle formed by a slope 2 on the second diffraction grating side of the first transition zone structure and the first surface of the light guide plate,
Δw is a tolerance of slope width of the second transition zone structure,
Δx is an error of x, and x is ((half total reflection interval of light beam)+ (integer multiple of total reflection interval of light beam)),
w₂ is width w2 of slope 2 on the second diffraction grating side of the first transition zone structure.
   <31>

The light guide plate unit according to any one of <21> to <30>, wherein
a zone of the light guide plate including the transition zone structure includes:
a reflective coating layer configured to prevent the light from entering the transition zone structure, or a coating layer configured to prevent light having entered the structure from causing an angle deviation due to a slope of the transition zone structure.
   <32>

The light guide plate unit according to <31>, wherein the reflective coating layer is between the light guide plate and the transition zone structure.

<33>

The light guide plate unit according to <31>, wherein a refractive index of the transition zone structure and a refractive index of a material included in the reflective coating layer are substantially the same.

<34>

The light guide plate unit according to <21>, wherein
the transition zone structure includes a plurality of vertices between the first diffraction grating and the second diffraction grating, wherein
heights of all of the plurality of vertices are equal to or less than 90 nm.
   <35>

The light guide plate unit according to any one of <21> to <34>, wherein
the first diffraction grating at least one of: diffracts light entering the light guide plate and causes the light to travel in the light guide plate, expands the light having traveled in the light guide plate, or emits the light from the light guide plate, and
the second diffraction grating diffracts light passing through the first diffraction grating and traveling toward an end of the light guide plate and causes the light to travel to the first diffraction grating again.
   <36>

The light guide plate unit according to any one of <21> to <34>, wherein
the first diffraction grating diffracts light entering the light guide plate and causes the light to travel in the light guide plate, and
the second diffraction grating expands the light diffracted by the first diffraction grating and having traveled in the light guide plate.
   <37>

The light guide plate unit according to any one of <21> to <34>, wherein
the first diffraction grating is an expander that expands light having traveled in the light guide plate, and
the second diffraction grating emits, from the light guide plate, light expanded by the expander.
   <38>

The light guide plate unit according to any one of <21> to <34>, wherein
the first diffraction grating diffracts light entering the light guide plate and causes the light to travel in the light guide plate, and
the second diffraction grating emits, from the light guide plate, light having traveled in the light guide plate.
   <39>

The light guide plate unit according to <38>, wherein the second diffraction grating expands light having traveled in the light guide plate and emits the light from the light guide plate.

<40>

The light guide plate unit according to any one of <21> to <39>, wherein the transition zone structure includes a material also included in the first diffraction grating, the second diffraction grating, or both of the first and second diffraction gratings.

<41>

The light guide plate unit according to any one of <21> to <40>, wherein the light guide plate unit is included in an image display device.

<42>

The light guide plate unit according to <21>, wherein the transition zone structure includes first and second vertices between the first and second end points.

<43>

The light guide plate unit according to <21>, wherein at least one of the first and second end points is within an area of a corresponding at least one of the first and second diffraction gratings.

<44>

An image display device, comprising:
a light guide plate unit, including:
a light guide plate;
a first diffraction grating provided on a first surface of the light guide plate;
a second diffraction grating on the first surface side of the light guide plate; and
a transition zone structure on the first surface side of the light guide plate, wherein the transition zone structure extends from a first end point at or adjacent to the first diffraction grating to a vertex point, and from the vertex point to a second end point at or adjacent to the second diffraction grating, and wherein the first and second end points are closer to the first surface of the light guide plate than the vertex.
   <45>

A light guide plate unit, comprising:
a light guide plate;
a first diffraction grating disposed on a first surface side of the light guide plate;
a second diffraction grating on the first surface side of the light guide plate;
a transition zone structure on the first surface side of the light guide plate, wherein a part of the transition zone structure is between the first diffraction grating and the second diffraction grating; and
a coating layer on at least portions of a side of the transition zone structure opposite a side of the transition zone structure adjacent the first surface side of the light guide plate.
   <46>

A light guide plate unit, comprising:
a light guide plate;
a first diffraction grating disposed on a first surface side of the light guide plate;
a second diffraction grating on the first surface side of the light guide plate;
a transition zone structure above the first surface side of the light guide plate, wherein a part of the transition zone structure is between the first diffraction grating and the second diffraction grating; and
a reflective coating layer on the first surface side of the light guide plate, wherein the reflective coating layer is disposed between the transition zone structure and the first surface side of the light guide plate.

Although the embodiments and examples of the present disclosure have been specifically described above, the present disclosure is not limited to the above-described embodiments and examples, and various modifications based on the technical idea of the present disclosure can be made.

For example, the configurations, methods, steps, shapes, materials, numerical values, and the like described in the above-described embodiments and examples are merely examples, and different configurations, methods, steps, shapes, materials, numerical values, and the like may be used as necessary. Furthermore, the configurations, methods, steps, shapes, materials, numerical values, and the like of the above-described embodiments and examples can be combined with one another without departing from the gist of the present disclosure.

Furthermore, in the present description, the numerical range indicated by using “to” indicates a range including numerical values described before and after “to” as a minimum value and a maximum value, respectively. In the numerical range described in stages in the present description, an upper limit value or a lower limit value of the numerical range of a certain stage may be replaced with an upper limit value or a lower limit value of the numerical range of another stage.

It should be understood by those skilled in the art that various modifications, combinations, sub-combinations and alterations may occur depending on design re-quirements and other factors insofar as they are within the scope of the appended claims or the equivalents thereof.

### REFERENCE SIGNS LIST

TZ Structure having mountain shape, or zone where the structure exists
G1 First diffraction grating
G2 Second diffraction grating
P Light guide plate

What is claimed is:

1. A light guide plate unit, comprising:
a light guide plate;
a first diffraction grating on a first surface side of the light guide plate;
a second diffraction grating on the first surface side of the light guide plate; and
a transition zone structure on the first surface side of the light guide plate, wherein the transition zone structure extends from a first end point at or adjacent to the first diffraction grating to a vertex point, and from the vertex point to a second end point at or between the first end point and the second diffraction grating, and wherein the first and second end points are closer to the first surface of the light guide plate than the vertex point.

2. The light guide plate unit according to claim 1, wherein
where a width of a first portion of the transition zone structure extending from the first end point to the vertex point is less than a total reflection interval of the light in the light guide plate, the width of the first portion of the transition zone structure is equal to or less than a threshold specified on a basis of the total reflection interval.

3. The light guide plate unit according to claim 1, wherein
where a width of a first portion of the transition zone structure extending from the first end point to the vertex point is equal to or greater than the total reflection interval of the light in the light guide plate, a height of the first portion of the transition zone structure is equal to or less than a threshold specified on a basis of the width of the first portion of the transition zone structure and an inclination angle of the first portion of the transition zone structure.

4. The light guide plate unit according to claim 1, wherein
the light guide plate unit is configured to satisfy a following Mathematical Expression 1 when an MTF value of light immediately before entering the transition zone structure in a case where a spatial frequency is 10 cycle/deg is X₁₀ and an MTF value of light immediately after passing through the transition zone structure is Y₁₀
$$\begin{matrix}[ Math . 1 ] & \\ 0 ≦ ( 1 - {Y}_{10} / {X}_{10} ) ≦ 0.5 . & ( Mathematical Expression 1 )\end{matrix}$$

5. The light guide plate unit according to claim 1, wherein
where each of a width w1 of a slope 1 on a first diffraction grating side of the transition zone structure and a width w2 of a slope 2 on a second diffraction grating side of the transition zone structure is equal to or greater than a total reflection interval d of the light in the light guide plate,
the transition zone structure has a height h1 of the slope 1 and a height h2 of the slope 2 satisfy a following Mathematical Expression 2,
$$\begin{matrix}[ Math . 2 ] & \\ \begin{matrix}0 < h 1 ≦ w 1 * tan ( 0.025 [ deg ] ⋆ A ) \\ and \\ 0 < h 2 ≦ w 2 * tan ( 0.025 [ deg ] ⋆ A )\end{matrix} \} & ( Mathematical Expression 2 )\end{matrix}$$
where, in Mathematical Expression 2,
h1=(height from reference surface of the first diffraction grating to the vertex point of the transition zone structure)
w1=(width of slope 1)
h2=(height from reference surface of the second diffraction grating to vertex of the transition zone structure)
w2=(width of slope 2)
$$A = cos ( {θ}_{airin} ) / ( 2 * {n}_{2} * cos ( {θ}_{TIR}^{′} ) )$$
θₐᵢᵣᵢₙ=(incident angle of the light when entering the light guide plate)
n₂=(refractive index of material of the transition zone structure)
θ′_{TIR}=(light guide angle in structure of the transition zone structure),
where the width w1 of the slope 1 on the first diffraction grating side of the transition zone structure is less than the total reflection interval d of the light in the light guide plate, and the width w2 of the slope 2 on the second diffraction grating side of the transition zone structure is equal to or greater than the total reflection interval d of the light in the light guide plate,
the width w1 of the slope 1 and the height h2 of the slope 2 satisfy a following Mathematical Expression 3,
$$\begin{matrix}[ Math . 3 ] & \\ \begin{matrix}0 < w 1 ≦ 0.23 * d \\ and \\ 0 < h 2 ≦ w 2 * tan ( 0. 25 [ deg ] ⋆ A )\end{matrix} \} & ( Mathematical Expression 3 )\end{matrix}$$
where, in Mathematical Expression 3,
w1=(width of slope 1)
h2=(height from reference surface of the second diffraction grating to vertex of the transition zone structure)
w2=(width of slope 2)
$$A = cos ( {θ}_{airin} ) / ( 2 * {n}_{2} * cos ( {θ}_{TIR}^{′} ) )$$
θₐᵢᵣᵢₙ=(incident angle of the light when entering the light guide plate)
n₂=(refractive index of material forming structure of the transition zone structure)
θ′_{TIR}=(light guide angle in structure of the transition zone structure),
and,
where each of the width w1 of the slope 1 on the first diffraction grating side and the width w2 of the slope 2 on the second diffraction grating side of the transition zone structure is less than the total reflection interval d of the light in the light guide plate,
the width w1 of the slope 1 and the width w2 of the slope 2 satisfy a following Mathematical Expression 4,
$$\begin{matrix}[ Math . 4 ] & \\ \begin{matrix}0 < w 1 ≦ 0.15 * d \\ and \\ 0 < w 2 ≦ 0.15 * d\end{matrix} \} & ( Mathematical Expression 4 )\end{matrix}$$
where, in Mathematical Expression 4,
w1=(width of slope 1)
w2=(width of slope 2).

6. The light guide plate unit according to claim 1, wherein
the light guide plate unit is configured to satisfy a following Mathematical Expression 5 when an MTF value of light immediately before entering the transition zone structure in a case where a spatial frequency is 20 cycle/deg is X₂₀ and an MTF value of light immediately after passing through the transition zone structure is Y₂₀
$$\begin{matrix}[ Math . 5 ] & \\ 0 ≦ ( 1 - {Y}_{20} / {X}_{20} ) ≦ 0.5 . & ( Mathematical Expression 5 )\end{matrix}$$

7. The light guide plate unit according to claim 6, wherein
where each of a width w1 of a slope 1 on the first diffraction grating side and a width w2 of a slope 2 on the second diffraction grating side of the transition zone structure is equal to or greater than a total reflection interval d of the light in the light guide plate,
the transition zone structure has a height h1 of the slope 1 and a height h2 of the slope 2 that satisfy a following Mathematical Expression 6,
$$\begin{matrix}[ Math . 6 ] & \\ \begin{matrix}0 < h 1 ≦ w 1 ⋆ tan ( 0.0125 [ deg ] ⋆ A ) \\ and \\ 0 < h 2 ≦ w 2 ⋆ tan ( 0.0125 [ deg ] ⋆ A )\end{matrix} \} & ( Mathematical Expression 6 )\end{matrix}$$
where, in Mathematical Expression 6,
h1=(height from reference surface of the first diffraction grating to vertex of the transition zone structure)
w1=(width of slope 1)
h2=(height from reference surface of the second diffraction grating to vertex of the transition zone structure)
w2=(width of slope 2)
$$A = cos ( {θ}_{airin} ) / ( 2 * {n}_{2} * cos ( {θ}_{TIR}^{′} ) )$$
θₐᵢᵣᵢₙ=(incident angle of the light when entering the light guide plate)
n₂=(refractive index of material forming structure of the transition zone structure)
θ′_{TIR}=(light guide angle in structure of the transition zone structure),
where the width w1 of the slope 1 on the first diffraction grating side of the transition zone structure is less than the total reflection interval d of the light in the light guide plate, and the width w2 of the slope 2 on the second diffraction grating side of the transition zone structure is equal to or greater than the total reflection interval d of the light in the light guide plate,
the width w1 of the slope 1 and the height h2 of the slope 2 of the transition zone structure satisfy a following Mathematical Expression 7,
$$\begin{matrix}[ Math . 7 ] & \\ \begin{matrix}0 < w 1 ≦ 0.2 * d \\ and \\ 0 < h 2 ≦ w 2 * tan ( 0.0125 [ deg ] ⋆ A )\end{matrix} \} & ( Mathematical Expression 7 )\end{matrix}$$
where, in Mathematical Expression 7,
w1=(width of slope 1)
h2=(height from reference surface of the second diffraction grating to vertex of the transition zone structure)
w2=(width of slope 2)
$$A = cos ( {θ}_{airin} ) / ( 2 * {n}_{2} * cos ( {θ}_{TIR}^{′} ) )$$
θₐᵢᵣᵢₙ=(incident angle of the light when entering the light guide plate)
n₂=(refractive index of material of the transition zone structure) θ′_{TIR}=(light guide angle in structure of the transition zone structure),
and,
where each of the width w1 of the slope 1 on the first diffraction grating side and the width w2 of the slope 2 on the second diffraction grating side of the transition zone structure is less than the total reflection interval d of the light in the light guide plate,
the width w1 of the slope 1 and the width w2 of the slope 2 of the transition zone structure satisfy a following Mathematical Expression 8,
$$\begin{matrix}[ Math . 8 ] & \\ \begin{matrix}0 < w 1 ≦ 0.15 * d \\ and \\ 0 < w 2 ≦ 0.15 * d\end{matrix} \} & ( Mathematical Expression 8 )\end{matrix}$$
where, in Mathematical Expression 8,
w1=(width of slope 1) w2=(width of slope 2).

8. The light guide plate unit according to claim 1, wherein
the transition zone structure is a first transition zone structure, wherein the light guide plate unit further including a second transition zone structure on the first surface or on another surface of the light guide plate, wherein the second transition zone structure extends from a third end point to a vertex point of the second transition zone structure, and from the vertex point of the second transition zone structure to a fourth end point, and wherein the third and fourth end points are closer to the first or the another surface of the light guide plate than the vertex.

9. The light guide plate unit according to claim 8, wherein
the width w1 of the slope 1 on the first diffraction grating side of the first transition zone structure is configured to satisfy
$$w 1 < 0.1 d$$
(where d is a total reflection interval of the light in the light guide plate).

10. The light guide plate unit according to claim 9, wherein
in a case where the width w2 of the slope 2 on the second diffraction grating side of the first transition zone structure is equal to or greater than the total reflection interval d of the light, the second transition zone structure is configured to satisfy any of a following Mathematical Expressions 9-1, 9-2, and 9-3,
$$\begin{matrix}[ Math . 9 ] & \\ \begin{matrix}- 1 \leq \frac{Δφ}{{φ}_{2}} \leq 1 - \vert \frac{Δ w}{d / 2} - 2 n \vert \\ \& \vert \frac{Δ w}{d / 2} - 2 n \vert \leq 1 \\ \& - {w}_{2} < Δ w\end{matrix} \} \\ or & ( Mathematical Expression 9 - 1 )\end{matrix}$$
$$\begin{matrix}- 1 \leq \frac{Δφ}{{φ}_{2}} \leq 1 - 4 \vert \frac{Δ x}{d / 2} - 2 n \vert \\ \& \vert \frac{Δ x}{d / 2} - 2 n \vert \leq \frac{1}{2}\end{matrix} \} \\ or \qquad ( Mathematical Expression 9 - 2 )$$
$$\begin{matrix}1 - 4 \vert \frac{Δ x}{d / 2} - 2 n \vert \leq \frac{Δφ}{{φ}_{2}} \leq - 1 \\ \& \frac{1}{2} \leq \vert \frac{Δ x}{d / 2} - 2 n \vert \leq 1\end{matrix} \} \qquad ( Mathematical Expression 9 - 3 )$$
where, in Mathematical Expressions 9-1, 9-2, and 9-3,
Δφ is a tolerance of slope angle of the second transition zone structure,
φ₂ is an angle formed by a slope 2 on the second diffraction grating side of the first transition zone structure and the first surface of the light guide plate,
Δw is a tolerance of slope width of the second transition zone structure, d is a total reflection interval of the light as described above,
n is an any integer,
Δx is an error of x, and x is ((half total reflection interval of light beam)+ (integer multiple of total reflection interval of light beam)),
w2 is width w2 of slope 2 on the second diffraction grating side of the first transition zone structure,
and
where the width w2 of the slope 2 on the second diffraction grating side of the first transition zone structure is less than the total reflection interval d of the light, the second transition zone structure is configured to satisfy any of a following Mathematical Expressions 10-1, 10-2, and 10-3,
$$\begin{matrix}[ Math . 10 ] & \\ \vert \frac{Δφ}{{φ}_{2}} \vert \leq 1 \& - 1 \leq \frac{Δ w}{{w}_{2}} \leq 0 \\ or & ( Mathematical Expression 10 - 1 )\end{matrix}$$
$$\vert \frac{Δφ}{{φ}_{2}} \vert \leq \frac{1}{4} \& 0 \leq \frac{Δ w}{{w}_{2}} \leq 1 \\ or \qquad ( Mathematical Expression 10 - 2 )$$
$$\vert \frac{Δφ}{{φ}_{2}} \vert \leq \frac{1}{2} \& \vert \frac{Δ w}{{w}_{2}} \vert \leq \frac{1}{2} \qquad ( Mathematical Expression 10 - 3 )$$
where, in Mathematical Expressions 10-1, 10-2, and 10-3,
Δφ is a tolerance of slope angle of the second transition zone structure,
φ₂ is an angle formed by a slope 2 on the second diffraction grating side of the first
transition zone structure and the first surface of the light guide plate,
Δw is a tolerance of slope width of the second transition zone structure,
Δx is an error of x, and x is ((half total reflection interval of light beam)+(integer multiple of total reflection interval of light beam)),
w2 is width w2 of slope 2 on the second diffraction grating side of the first transition zone structure.

11. The light guide plate unit according to claim 1, wherein
a zone of the light guide plate including the transition zone structure includes:
a reflective coating layer configured to prevent the light from entering the transition zone structure, or a coating layer configured to prevent light having entered the structure from causing an angle deviation due to a slope of the transition zone structure.

12. The light guide plate unit according to claim 11, wherein the reflective coating layer is between the light guide plate and the transition zone structure.

13. The light guide plate unit according to claim 11, wherein a refractive index of the transition zone structure and a refractive index of a material included in the reflective coating layer are substantially the same.

14. The light guide plate unit according to claim 1, wherein
the transition zone structure includes a plurality of vertices between the first diffraction grating and the second diffraction grating, wherein
heights of all of the plurality of vertices are equal to or less than 90 nm.

15. The light guide plate unit according to claim 1, wherein
the first diffraction grating at least one of: diffracts light entering the light guide plate and causes the light to travel in the light guide plate, expands the light having traveled in the light guide plate, or emits the light from the light guide plate, and
the second diffraction grating diffracts light passing through the first diffraction grating and traveling toward an end of the light guide plate and causes the light to travel to the first diffraction grating again.

16. The light guide plate unit according to claim 1, wherein
the first diffraction grating diffracts light entering the light guide plate and causes the light to travel in the light guide plate, and
the second diffraction grating expands the light diffracted by the first diffraction grating and having traveled in the light guide plate.

17. The light guide plate unit according to claim 1, wherein
the first diffraction grating is an expander that expands light having traveled in the light guide plate, and
the second diffraction grating emits, from the light guide plate, light expanded by the expander.

18. The light guide plate unit according to claim 1, wherein
the first diffraction grating diffracts light entering the light guide plate and causes the light to travel in the light guide plate, and
the second diffraction grating emits, from the light guide plate, light having traveled in the light guide plate.

19. The light guide plate unit according to claim 18, wherein the second diffraction grating expands light having traveled in the light guide plate and emits the light from the light guide plate.

20. The light guide plate unit according to claim 1, wherein the transition zone structure includes a material also included in the first diffraction grating, the second diffraction grating, or both of the first and second diffraction gratings.

21. The light guide plate unit according to claim 1, wherein the light guide plate unit is included in an image display device.

22. The light guide plate unit according to claim 1, wherein the transition zone structure includes first and second vertices between the first and second end points.

23. The light guide plate unit according to claim 1, wherein at least one of the first and second end points is within an area of a corresponding at least one of the first and second diffraction gratings.

24. An image display device, comprising:
a light guide plate unit, including:
a light guide plate;
a first diffraction grating provided on a first surface of the light guide plate;
a second diffraction grating on the first surface side of the light guide plate; and
a transition zone structure on the first surface side of the light guide plate, wherein the transition zone structure extends from a first end point at or adjacent to the first diffraction grating to a vertex point, and from the vertex point to a second end point at or adjacent to the second diffraction grating, and wherein the first and second end points are closer to the first surface of the light guide plate than the vertex.

25. A light guide plate unit, comprising:
a light guide plate;
a first diffraction grating disposed on a first surface side of the light guide plate;
a second diffraction grating on the first surface side of the light guide plate;
a transition zone structure on the first surface side of the light guide plate, wherein a part of the transition zone structure is between the first diffraction grating and the second diffraction grating; and
a coating layer on at least portions of a side of the transition zone structure opposite a side of the transition zone structure adjacent the first surface side of the light guide plate.

26. A light guide plate unit, comprising:
a light guide plate;
a first diffraction grating disposed on a first surface side of the light guide plate;
a second diffraction grating on the first surface side of the light guide plate;
a transition zone structure above the first surface side of the light guide plate, wherein a part of the transition zone structure is between the first diffraction grating and the second diffraction grating; and
a reflective coating layer on the first surface side of the light guide plate, wherein the reflective coating layer is disposed between the transition zone structure and the first surface side of the light guide plate.
